(19) United States
(12) Patent Application Publication
(10) Pub. No.: US 2024/0030400 A1
(43) Pub. Date: Jan. 25, 2024

(54) METHODS OF MAKING TEXTURED METALS, TEXTURED METALS, AND USES THEREOF

(71) Applicant: CORNELL UNIVERSITY, Ithaca, NY (US)

(72) Inventors: Lynden A. Archer, Ithaca, NY (US); Jingxu Zheng, Shenzhen (CN)

(21) Appl. No.: 18/356,139

(22) Filed: Jul. 20, 2023

Related U.S. Application Data
(60) Provisional application No. 63/390,820, filed on Jul. 20, 2022.

(51) Int. Cl. H01M 4/04; H01M 4/38

(52) U.S. Cl. CPC H01M 4/0435; H01M 4/38; H01M 2004/027

(57) ABSTRACT

Methods of making a textured metal or a textured metal layer, anodes, and devices. In various examples, a method comprises rolling a metal; and folding the rolled metal. In various examples, the rolling and folding are repeated a desired number of times. In various examples, the rolling(s) result(s) in severe plastic deformation (SPD) of the metal, anisotropic deformation(s), or alignment of the metal, or any combination thereof. In various examples, the metal comprises potassium, sodium, lithium, zinc, magnesium, aluminum, calcium, or the like, or any combination thereof. In various examples, an anode comprises a textured metal. In various examples, the textured metal epitaxially templates deposition of the reduced form of metal-ions of a metal ion-conducting electrochemical device. In various examples, a device, such as, for example, a battery (e.g., an ion-conducting battery), a supercapacitor, a fuel cell, an electrolyzer, or an electrolytic cell, comprises one or more of the anode(s).

### CROSS-REFERENCE TO RELATED APPLICATIONS

This application claims the benefit of U.S. Provisional Patent Application No. 63/390,820, filed Jul. 20, 2022; the contents of the above-identified application are hereby fully incorporated herein by reference in their entirety.

### STATEMENT REGARDING FEDERALLY SPONSORED RESEARCH

This invention was made with government support under grant no. DE-SC0012673 awarded by the Department of Energy. The government has certain rights in the invention.

### BACKGROUND

Metal electrodes have been widely deployed since the early 20^{th} century to store energy in battery systems. In their early forms, the batteries operated as single-charge devices—called primary batteries, e.g., AA alkaline battery (Zn—MnO₂) The electrochemical deposition process is an area of interest due to the important role it plays in the reversibility of energy storage in secondary/rechargeable batteries that utilize electrochemically active metals, including Li, Na, K, Ca, Mg, Zn, and Al as anodes for achieving high cell-level energy storage per unit mass or volume. Such batteries derive their high storage capacity both from the fact that they do not require inactive host materials, such as graphite, to intercalate metal ions during the charge cycle and because oxidation of the metal anode provides an intrinsic source of metal ions. This last trait is particularly significant because it enables rechargeable batteries-based cathodes composed of essentially any electrochemically active molecule (e.g., sulfur, oxygen, carbon dioxide, and transition metal compounds) able to undergo reversible redox reactions with the metal ions of interest. In comparison with an intercalating anode, the advantage of a metal anode is therefore on the one hand obvious—the weight, volume from the intercalation host material can be saved and the versatility of cathode choices may lead to dramatic enhancements in the amount of energy stored per unit mass or volume—but on the other hand leads to as significant downsides—the uneven electrodeposition of metals not only leads to material loss via multiple mechanisms but also raises serious safety concerns associated with short circuiting due to the penetration of electrodeposited metal through the separator (see left model in FIG. 1A).

The propensity of metals to form irregular and non-planar electrodeposits at liquid/solid interfaces has emerged as a fundamental barrier to high-energy, rechargeable batteries that utilize metal anodes. The problem of rough, dendritic electrodeposition of metals plays a role in premature failure and short-circuiting of high-capacity metallic battery anodes. Classical transport theory predicts that the growth and proliferation of such dendrites are the result of a combination of morphological and hydrodynamic instabilities, which lead to complex interfacial transport behaviors, including formation of an ion depleted Extended Space Charge Layer (ESCL) near any ion selective interphase in an electrolyte and to the nucleation and rapid growth of diffusion-limited, classical tree-like structures termed dendrites. Dendritic electrodeposition is fundamentally unsafe in the battery context because once formed at a battery anode, dendrites may grow aggressively to fill the inter-electrode space, short-circuiting the battery.

The recent decade witnessed a revival of research interest in metal electrodes that can work reversibly in rechargeable batteries. In this scenario, the metal is repeatedly plated and stripped during battery charge and discharge, respectively. The key issue faced by metal anodes in this new context is the formation of a heterogeneous, porous electrodeposition morphology that causes fast capacity fading and battery failure by various processes. These failure modes can be addressed in various ways by regulating deposition rate, electrolyte electrochemistry, interphase transport characteristics, and electrode geometry (e.g., non-planar/3D electrodes) but are understood to originate from fundamental characteristics associated with metal crystallization and dissolution processes that determine the repeatability of the stripping and plating processes required to achieve long battery lifetimes. This has in-turn re-introduced a many-decades old challenge, which was addressed by numerous investigators but remained unsolved before the development of intercalation battery electrodes allowed it to be ignored in pursuit of practical battery cells. The challenge is how to impose effective and sustained regulation on fundamentally crystalline metal deposits at planar interfaces during repeated cycles of electro-plating/stripping in a closed battery cell.

The porous, ramified electrode landscape developed during repeated cycles of plating/stripping of a metal anode is now believed to stem from multiple fundamental instabilities, either physical (e.g., mass transport limit, uneven electrical field distribution), or chemical (e.g., heterogeneous solid-electrolyte interphase), and sometimes their interplay. The resultant complexity poses obvious challenges to development of secondary batteries based on metal electrodes that can achieve performance and lifetime operations at scale that are truly competitive (on either a weight or volume basis) with already commercial rechargeable battery technology based on intercalation electrodes. Very recently, a small number of works revealed that the crystallography of metal deposits plays a critical but previously underexplored role in the plating/stripping. These studies showed, in particular that the crystallographic features of a metal deposit formed at the interface can serve as a sensitive indicator of the electrodeposition quality. In this regard, various crystallographic descriptors, including the geometry of the crystallite building blocks and the orientational order parameter with respect to the electrode surface have been employed. A universal rule, independently established in different metal systems, e.g., Zn and Li, is that stable plating/stripping can be achieved when the deposits exhibit a strong crystallographic texture (e.g., as produced by aligning the close-packed crystal plane with the substrate). Multiple approaches for obtaining such textured metal deposits have been proposed, including heteroepitaxy, convective flow, electrolyte additive and so on; it is remarkable that all appear to be successful in controlling the metal electrodeposit morphology during the plating process.

Noticeable is that these prior studies focus on metal deposition on substrates that are of chemistries different from the metal—such as Li on Cu, Zn on carbon, Zn on stainless steel, etc., whereas in a deployable battery setup, the working anode in the form as a thin metal foil pre-stored in the battery. The amount of the prestored metal typically exceeds—by at least one order of magnitude in most state-of-the-art studies—the amount that is plated/stripped in each battery cycle. However, to be truly competitive with state-of-the art rechargeable batteries, nearly the full amount of the prestored metal must be utilized in each-and-every cycle of discharge and charge. This in turn means that the path towards practical metal anode batteries requires processes for creating extremely thin metal anodes that preserve the full electrochemical activity of the metal during battery lifetime. It also means that the role the native crystallography of these metal foils play in the evolving electrode morphology cannot be overlooked. As we will soon see, the crystallographic heterogeneity of most commercial metal foils, featuring broad size and orientation distribution of the grains, externalizes itself through morphological and electrochemical instabilities that lead to battery failure during cycling. There are two fundamental origins of these instabilities. First, the dissolution rate of the metal is dependent on the exposed crystallographic facet. This means that the orientational heterogeneity of the grains will translate into morphological heterogeneity upon battery discharge. Second, electrodeposition on the metal foil is determined by homoepitaxy, wherein the built-in crystallographic heterogeneity templates the morphology adopted by the newly-deposited metal upon battery recharge. Strong interventions are therefore needed to control the built-in crystallographic heterogeneities of the metal electrodes.

Using single crystalline metals as anodes in batteries provides a number of advantages. The growth of single crystalline metals has also been long pursued due to its technological importance—for example—in manufacturing turbine blades or condensed matter physics research. Unfortunately, the cost ($100˜1000/cm²) and time needed to produce such high-quality single crystals at macroscopic scales, eliminates any advantages even the most cost-effective of these metals bring to energy storage technology—effectively ruling out existing approaches for producing such materials. Scalable, cost-competitive approaches for controlling the crystallographic properties of metal electrodes is consequently of interest both for fundamental reasons (e.g., for evaluating our hypothesis) and for practical rechargeable batteries with long cycle life.

### SUMMARY OF THE DISCLOSURE

The present disclosure provides, inter alia, methods of making textured metals and textured metal layers. The present disclosure also provides uses of the textured metals and textured metal layers, such as, for example, in anodes and devices comprising one or more textured metal(s) and/or one or more textured metal layer(s).

In various examples, a method of making a textured metal layer comprises: rolling a metal; and folding the rolled metal. In various examples, the rolling and folding are repeated from 1 to 20 times, including all integer repetitions and ranges therebetween. In various examples, the metal is a metal foil, a metal film, a metal ribbon, a metal strip, or a metal tape, or the like. In various examples, the rolling results in severe plastic deformation (SPD) of the metal or the like. In various examples, the rolling results in anisotropic deformation(s) of the metal or the like. In various examples, the anisotropic deformation(s) are in-plane shear or the like. In various examples, the rolling results in in-plane alignment of one or more crystal plane(s) of the metal in-plane, in in-plane alignment of one or more crystal plane(s) of the metal in-plane and out-of-plane alignment of one or more crystal plane(s) of the metal, or the like. In various examples, the alignment occurs preferentially of one or more or all (002) plane(s) in a hexagonal close packed metal, at one or more or all (110) plane(s) in a body-centered cubic (bcc) metal, or one or more or all (111) plane(s) in a face centered cubic metal, or the like. In various examples, each rolling is independently carried out at a temperature of about 0.3 to about 0.99 of the melting temperature (Tₘ) of the metal, including all 0.05 values and ranges therebetween. In various examples, each folding is folding the metal in about half. In various examples, the metal is a hexagonal close packed metal, a bcc metal, or a fcc metal, or the metal exhibits a homologous temperature (T_{H}) of greater than or equal to about 0.4, or the like, or both. In various examples, the metal comprises potassium, sodium, lithium, zinc, magnesium, aluminum, calcium, or any combination thereof. In various examples, the metal comprises a metal chosen from gold, silver, indium, tin, cerium, lanthanum, thulium, zirconium, titanium, iron, and chromium, and combinations thereof.

In various examples, an anode comprises: i) one or more textured metal layer(s) of the present disclosure (such as, for example, one or more of the textured metal layer(s) above), or ii) one or more textured metal layer(s) of the present disclosure (such as, for example, one or more of the above textured metal layer(s)) disposed on at least a portion of a metal member (e.g., a first metal member) or the like. In various examples, the textured metal layer, which may be a metal member (e.g., a second metal member), comprises (or is) a metal chosen from gold, silver, indium, tin, cerium, lanthanum, thulium, zirconium, titanium, iron, and chromium, and combinations thereof. In various examples, the textured metal comprises (or is) potassium, sodium, lithium, zinc, magnesium, aluminum, calcium, or any combination thereof. In various examples, at least a portion of, substantially all, or all of the textured metal is crystalline. In various examples, at least a portion or all of an exterior surface of the textured metal comprises crystal facets chosen from a (001) plane in hexagonal closest packed structure, a (111) plane in face centered cubic structure, and a (110) plane in body centered cubic structure, and the like. In various examples, 80%-100% (%=percent), including all 0.1% values and ranges therebetween, of the crystal facets of the textured metal are a (001) plane in hexagonal closest packed structure, a (111) plane in face centered cubic structure, or a (110) plane in body centered cubic structure, or the like. In various examples, the textured metal layer comprises a plurality of grains independently comprising a longest linear dimension of about 5 nanometers (nm) to about less than about 1 micron, including all 0.1 nm values and ranges therebetween. In various examples, the thickness of the textured metal is about 10 nanometers to about 5 centimeters, including all integer nanometer values and ranges therebetween. In various examples, the anode further comprises an electrodeposited layer disposed on at least a portion of the textured metal layer.

In various examples, a device comprises one or more anode(s) of the present disclosure (such as, for example, one or more of the anode(s) above). In various examples, the device is an electrochemical device or the like. In various examples, the electrochemical device is or comprises a battery, a supercapacitor, a fuel cell, an electrolyzer, or an electrolytic cell, or the like. In various examples, the battery is a metal ion-conducting battery or the like. In various examples, the ion-conducting battery is a lithium-ion conducting battery, a potassium-ion conducting battery, a sodium-ion conducting battery, a calcium-ion conducting battery, a magnesium-ion conducting battery, a zinc-ion conducting battery, an aluminum-ion conducting battery, or an iron-ion conducting battery, or the like. In various examples, the battery exhibits one or more or all of the following: the battery does not exhibit detectible dendritic growth and/or orphaning; and/or a battery exhibits at least about 1,000 charging/discharging cycles without failure; and/or an areal capacity of about 0.5 to about 50 mAh/cm² at a current density of about 0.1 to about 100 mA/cm²; and/or an N:P ratio of about 0 to about 10; and/or a current density of about 0.1 to about 100 mA/cm².

### BRIEF DESCRIPTION OF THE FIGURES

For a fuller understanding of the nature and objects of the disclosure, reference should be made to the following detailed description taken in conjunction with the accompanying figures.

FIG. 1 show a schematic illustrating how an ARB process can be used to eliminate crystallography heterogeneity of metal electrodes. (A) Microstructures of the grains in as-obtained commercial Zn metal foils (left), and the morphology after plating/stripping cycles in an electrochemical cell. (B) Slip mechanism for HCP metals: (002) close-packed plane along <110> close-packed direction. (C) Accumulative roll bonding (ARB) enables arbitrarily large nominal deformation reduction rate of metal foils. After each rolling pass, the as-rolled metal foil is folded (bonding) and then rolled again. A specified nominal strain can be achieved by repeating the roll-bonding cycles for a pre-determined number of cycles.

FIG. 2 shows crystallographic characterization of Zn metal foils subject to ARB treatment. (A) 2D X-ray diffraction patterns obtained for Zn foils before and after the number of accumulative roll bonding (ARB) cycles specified for each pattern, 2θ=36.2 degree. (B) Texture evolution during the ARB process. Red data points show the ratio between the (002) and total diffraction intensity. Blue data points show the full width at half maximum of (002) diffraction intensity along a range of χ angles. (C) X-ray diffraction line scans. (D) (002) diffraction intensity along χ angle. (E) Cs-corrected HAADF-STEM images of ARB treated Zn.

FIG. 3 shows metallographic characterization of Zn foils. Optical microscopy characterization of (A)(B) two conventional commercial Zn foils, and (C) ARB (002)-textured Zn foil. Scanning electron microscopy characterization of (D)(E)(G)(H) the conventional Zn foils, and (F)(I) ARB (002)-textured Zn foil. The false colors in FIGS. 3G and 3H show different domains as identified by their distinctive surface topographies after etching. The foils are anodized (also known as “electropolished”) before microscopy observation at 5 mA/cm² for 1 min.

FIG. 4 shows surface morphology of Zn electrodes after plating/stripping cycles. Photos of cycled (A) commercial Zn foil and (B) ARB treated Zn foil. Optical microscopy images of cycled (C) commercial Zn foil and (D) ARB Zn foil. Scanning electron microscopy images of cycled (E) commercial Zn foil and (F) ARB Zn foil. Condition: 8 mA/cm², 0.4 mAh/cm² for 10 plating/stripping cycles.

FIG. 5 shows electrochemical performance of Zn electrodes in symmetric battery cells. Plating/stripping cycling voltage profiles of (A) commercial Zn foil and (B) ARB (002)-textured Zn foil. Detailed plating/stripping voltage profile of (002)-textured Zn foil after (C) 100 and (D) 200 cycles. Zn∥NaV₃O₈ full batteries using (E) commercial Zn electrode with N:P>100 and (F) ARB (002)-textured electrodes with N:P≈5.

FIG. 6 shows crystallographic evolution in Na and Li metal electrodes subject to accumulative roll bonding. The x-ray diffraction intensity of (200) divided by the total diffraction intensity in (A) Na sample and (B) Li sample. Representative two-theta line scans on (C) Na sample and (D) Li sample.

FIG. 7 shows structure of hexagonal close-packed (HCP) and body-centered cubic (BCC) crystals. The pictures show the atomic arrangements viewed from the representative low-index zone axes as specified. Among metals of interest in the battery anode context, Zn/Mg belong to HCP, whereas Li/Na/K belong to BCC.

FIG. 8 shows X-ray diffraction line scans of a Zn foil subjected to ARB.

FIG. 9 shows preparation of the Zn S/TEM sample using focused ion beam (FIB). The pictures are secondary electron images showing the main steps in the FIB process.

FIG. 10 shows low magnification HAADF-STEM image of the TEM lamella lifted out from the surface of the ARB-treated Zn electrode.

FIG. 11 shows S/TEM images of the lamella lifted out from the surface of the commercial Zn electrode. Low-magnification (A)HAADF-STEM image and (B)TEM image of the sample. As can be inferred from the diffraction contrast, the grain size is significantly greater than the dimension of lamella, i.e. a few microns. (C) atomic resolution HAADF-STEM image of a grain. It shows a random orientation with respect to the surface of the sample. This should be compared with FIG. 2E; grains in ARB-treated Zn sample will show a lock orientational relation: ND//[002]_{Zn}. The atomic arrangement in FIG. 10C is consistent with the projected view of the Zn crystal as illustrated in FIG. 7.

FIG. 12 shows a schematic diagram showing an example of the bulk texture is different from real surface termination. In this case, while the bulk generates a strong (002) XRD intensity, the electrochemical interface lies on (101). This analysis underscores the necessity of using advanced Cs-corrected resolution HAADF-STEM to visualize the local surface atomic structure, complementing the XRD analyses.

FIG. 13 shows morphological and chemical characterization of Zn foils before electrochemical cycling. SEM images of (A) pristine commercial Zn foil and (B) ARB Zn foil. EDS of (C) pristine commercial Zn foil and (D) ARB Zn foil.

FIG. 14 shows chemical characterization of Zn foils after electrochemical cycling. (A) Weight contents of oxygen and sulfur detected by EDS on commercial and ARB Zn foils (averaged over 4 scans), respectively. Representative EDS collected from cycled Zn foils: (B) commercial Zn, (C) ARB Zn. After cycling, the contents of oxygen and sulfur on commercial Zn are significantly greater than ARB Zn. This suggests the (002)-texture could improve the chemical stability of the interface and reduce parasitic reactions that generate oxygen/sulfur-enriched passivating layers (e.g., SEI).

FIG. 15 shows pouch cell cycling test of Zn batteries. (A) Photo of a pouch cell made of Zn∥NaV₃O₈ electrodes. Cycling performance of Zn∥NaV₃O₈ full battery using (B) commercial Zn metal anodes and (C) textured Zn electrodes. The capacity retention and Coulombic efficiency of a full battery using commercial non-textured Zn electrodes is shown. Obvious performance deterioration is seen after around 50 cycles. In the initial stage, the Coulombic efficiency starts to decrease from the original value close to 100%; this is suggestive of “soft”/micro-shorts, in which case the dendrites very locally penetrate the separator and bridges the two electrodes. In the second stage, both the Coulombic efficiency and the discharge capacity decline quickly; and in the final stage, the cell is completely shorted by dendrites. This exemplifies the critical importance of imposing strong, robust regulation on the Zn electroplating morphology, particularly in larger cells.

FIG. 16 shows effect of electrolyte refilling on capacity retention of Zn∥NaV₃O₈ full batteries (using coin-type cell). The capacity loss originating from electrolyte decomposition is nearly fully recovered by simply refilling the ZnSO_{4(aq)} solution after a few thousand cycles. This means that, manual or automated electrolyte replenishment every a few to ten years could offset the electrolyte loss and its negative effects. Viewed from another perspective, these results in again proves that both the textured Zn anodes and non-planar NaV₃O₈ cathodes are highly stable against prolonged cycling (thousands of times), and that the major fading mechanism is the gradual electrolyte loss.

FIG. 17 shows effect of texturing on dissolution morphology of Na electrodes. SEM images of (A)(B) commercial Na foil and (C)(D) ARB-treated Na foil after electrochemical anodization (0.15 mA/cm² for 90 minutes).

FIG. 18 shows effect of texturing on dissolution morphology of Li electrodes. SEM images of (A)(B) commercial Li foil and (C)(D) ARB-treated Li foil after electrochemical anodization (0.15 mA/cm² for 90 minutes).

FIG. 19 shows electrochemical plating/stripping reversibility of Na and Li metal anodes w/and w/o ARB. Symmetric cell cycling of (A) Na and (B) Li. For both Na and Li, the textured electrodes demonstrate remarkably superior cycling stability as evidenced in the voltage profiles. Conditions: 0.5 mA/cm², 1 mAh/cm² for Na (in 1M NaPF₆ in EC/PC); 1 mA/cm², 1 mAh/cm² for Li (in 1M LiPF₆ in EC/DMC).

### DETAILED DESCRIPTION OF THE DISCLOSURE

Although subject matter of the present disclosure is described in terms of certain embodiments and examples, other embodiments and examples, including embodiments and examples that do not provide all of the benefits and features set forth herein, are also within the scope of this disclosure. For example, various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g., 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about”, it will be understood that the particular value forms a further disclosure. For example, if the value “about 10” is disclosed, then “10” is also disclosed.

The present disclosure describes, inter alia, methods for creating textured metals. A metal anode may comprise one or more of the textured metal(s), for example, for rechargeable batteries or the like, with desirable levels of reversibility. In various examples, a metal anode comprises a metal layer (e.g., an electrochemically active metal layer), with low lattice misfit (e.g., less than about 15%) for the metal anode, are used to facilitate reversible electrodeposition of the metal during the charge and discharge processes.

The present disclosure can address multiple barriers to practical rechargeable batteries that use metal anodes for achieving high energy and power. First, it can promote formation of low-surface area, dense deposits which limit active electrode material loss due to parasitic reactions with liquid and solid-state electrolyte. Second, it can delay the onset of morphological instabilities that produce dendritic electrodeposition during recharge of a metal anode, and which are known to produce catastrophic battery failure when dendrites become large-enough to produce internal short circuits in a battery. Finally, the templated metal can produce stronger anchoring of the metal electrodeposits to a bulk-like crystalline phase, which prevents physical loss (“orphaning”) of the active electrode material as a result of mechanical breakage and electrical disconnection of portions of the metal electrode during cycles of battery discharge and charge.

The present disclosure can address a long-standing problem associated with the propensity of all metals to form non-uniform, rough/dendritic electrodeposits with crystal structures that can be completely different from those observed in the bulk. This problem has re-emerged in recent years because rough deposition of metals is now known to pose a particularly stubborn impediment to progress towards practical rechargeable batteries that utilize metals as anodes for achieving high-energy charge storage. The present disclosure of atomic-scale intervention via an epitaxial mechanism can be used, for example, to regulate the nucleation, growth, and morphological evolution of metal electrode(s) and/or electrodeposited metal(s) inside a battery. It may be desirable that the templated material is electrochemically inert at the potentials at which the metal is deposited and removed from the battery electrode.

The present disclosure, in various examples, describes formation of a Zn anode. In so doing, examples of crystallographic, surface texturing, and electrochemical properties that result in reversible epitaxial electrodeposition at a Zn anode were demonstrated.

In an aspect, the present disclosure provides methods of making textured metals and anodes of the present disclosure. The methods are based on application of mechanical force to a metal (e.g., use of accumulative roll bonding (ARB) methodology or the like). In various examples, a textured metal layer comprises a textured metal. In various examples, the texture forming only results from application of mechanical force. In various examples, a method produces a textured metal or anode of the present disclosure. Non-limiting examples of methods are provided herein.

In an example, a method of making a textured metal or a textured metal layer (e.g., a metal comprising an exterior layer of a textured metal) comprises one or more accumulative roll bonding (ARB) process(es). In various examples, a method of forming a textured metal or a textured metal layer comprises rolling a metal; folding the rolled metal; and optionally, repeating the rolling and/or folding (e.g., bonding or the like) a desired number of times (e.g., until a desired texture is obtained, such as, for example, 1 to 20 times). In various examples, the rolling results in severe plastic deformation (SPD) of the metal. In various examples, each rolling is carried out at a temperature of about 0.3 to about 0.99 of the melting temperature (Tₘ) of the metal. In various examples, the metal or metal alloy is (or comprises) a hexagonal close packed metal or the like. In various examples, the metal is a metal or metal alloy.

In various examples, a second and any subsequent rolling steps are carried out using roller(s) and the rolling step(s). In various examples, a second and any subsequent rolling steps are carried out with the same orientation of metal with respect to the roller(s).

In various examples, the metal is a metal or metal alloy foil, a metal or metal alloy film, a metal or metal alloy ribbon, a metal or metal alloy strip, a metal or metal alloy tape, or the like and/or the metal or metal alloy comprises a thickness (e.g., an axis parallel to the shortest linear dimension of the foil, film, ribbon, strip, tape, or the like) of about 10 nanometers to about centimeters, including all integer nanometer values and ranges therebetween. In various examples, a metal or metal alloy foil, a metal or metal alloy film, a metal or metal alloy ribbon, a metal or metal alloy strip, a metal or metal alloy tape, or the like and/or defines a plane perpendicular to the thickness of the foil, film, ribbon, strip, tape, or the like. The area of the plane is not particularly limited. One of ordinary skill in the art would appreciate that foils, films, ribbons, strips, tapes, or the like having various areas can be subject to the process. In various examples, a metal or metal alloy foil, a metal or metal alloy film, a metal or metal alloy ribbon, a metal or metal alloy strip, a metal or metal alloy tape, or the like comprises an area of greater than about 100 cm², greater than about 250 cm², greater than about 500 cm², or greater than about 1000 cm². In various examples, the textured metal or textured metal layer comprises (or exhibits) a texture described herein (e.g., a texture described in Table 2 of Example 1, or the like).

In various examples, a metal is a single layer. In various examples, a metal does not comprise a plurality of metal layers.

In various examples, a method provides a textured metal or textured metal layer comprising a desired in-plane orientational order and/or a desired out-of-plane orientational order. In various examples, a method provides a textured metal having a desired in-plane orientational order and out-of-plane orientational order. In various examples, a textured metal having “orientational order” (e.g., in-plane orientational order and/or out-of-plane orientational order, or the like) comprises grains where about 50% or more, about 60% or more, about 70% or more, about 80% or more, about 90% or more, about 95% or more, about 98% or more, about 99% or more, about 99.5% or more, about 99.9% or more, about 100% of the grains (e.g., a plane of the grains, such as, for example, a low index crystal plane or the like, of the grains) are substantially aligned (e.g., a plane of a grain is within ±5 degrees or less, 4 degrees or less, 3 degrees or less, 2 degrees or less, 1 degrees or less) or aligned with the same plane of one or more of plurality of other grains of the textured metal. In various examples, a textured metal having “orientational order” (e.g., in-plane orientational order and/or out-of-plane orientational order, or the like) comprises adjacent grains (e.g., a grain its nearest neighbor or the like), where about 50% or more, about 60% or more, about 70% or more, about 80% or more, about 90% or more, about 95% or more, about 98% or more, about 99% or more, about 99.5% or more, about 99.9% or more, about 100% of the adjacent grains (e.g., a plane of the grains, such as, for example, a low index crystal plane or the like, of the grains) are substantially aligned (e.g., a plane of a grain is within ±5 degrees or less, 4 degrees or less, 3 degrees or less, 2 degrees or less, 1 degrees or less) or aligned. The orientational order of a textured metal can be determined by methods known in the art. In various examples, the orientational order of a textured metal is determined by x-ray analysis, or the like.

In various examples, a method provides a textured metal and/or textured metal layer comprising grains. In various examples, a grain comprises a linear dimension (which may be a longest linear dimension or the like) or the like or the grains comprise an average linear dimension (which may be a longest linear dimension or the like) or the like of about 5 nm to less than about 1 micron, including all 0.1 nm values and ranges therebetween (e.g., about 5 nm to about 990 nm, about 10 nm to about 950 nm, about 10 nm to about 900 nm).

In an aspect, the present disclosure provides textured metals. In various examples, a textured metal is (or is part of a) metal anode, such as, for example, a reversible metal anodes. A textured metal may be an epitaxial textured metal (e.g., exhibit a desirable amount of lattice mismatch with an electrodeposited layer). A textured metal may further comprise a metal layer (other than or in addition to the textured metal, such as, for example, a metal layer formed by epitaxial (e.g., low lattice mismatch) electrodeposition, which may be reversible, of the reduced form of the metal ions of a metal-ion conducting electrochemical device. In various examples, the metal layer is disposed on at least a portion of one or more exterior surface(s) of the textured metal layer. Lattice mismatch may also be referred to as lattice misfit. The textured metal may be referred to as a base layer. In various examples, a textured metal is made by a method of the present disclosure. Non-limiting examples of textured metals are provided herein.

In various examples, a textured metal provides a surface that results in epitaxial (e.g., low lattice mismatch) electrodeposition, which may be reversible, of the reduced form of the metal ions of metal-ion conducting electrochemical devices. Without intending to be bound by any particular theory, it is considered that a textured metal promotes epitaxial (e.g., low lattice mismatch) electrodeposition of the reduced form of the metal ions of metal-ion conducting electrochemical devices. In various examples, the electrodeposited metals have the same or similar crystal structures to those observed in the bulk material of the textured metal. As an illustrative example, a textured metal provides a surface that results in epitaxial (e.g., low lattice mismatch) electrodeposition, which may be reversible, of lithium metal of a lithium-ion conducting electrochemical device (e.g., a lithium-ion conducting battery such as, for example, a primary or secondary lithium-ion conducting battery or the like).

It is desirable that a textured metal results in epitaxial electrodeposition, which may be reversible, of a metal. It is desirable that textured metal is conductive (e.g., able to conduct electrons) so that the electrochemical deposition can occur. In certain examples, a textured metal preferentially exposing certain crystal facets. Without intending to be bound by any particular theory, it is considered that when the lattice misfit between a textured metal and the metal is low, the epitaxial effect is strong.

An epitaxial textured metal may exhibit a desirable amount of lattice strain (particularly, with regard to a first metal layer deposited on a textured metal) and/or lattice mismatch. Epitaxial growth of films of metal layer may be based on specific interface structures between the crystal lattices of the layer (aepi), which would be the metal layer (e.g., the reduced form of the metal ions of the metal-ion conducting electrochemical device) formed on the epitaxial textured metal, and substrate (a_{sub}), which refers to the epitaxial textured metal. These interfaces may be characterized by the lattice mismatch, which may be defined as f, where

$$f = \frac{{a}_{sub} - {a}_{epi}}{{a}_{sub}} .$$

The textured metal may have a 20% or less lattice mismatch (e.g., 10% or less, 5% or less, 4% or less, 3% or less, 2% or less, or 1% or less), which may be f, with the reduced form (i.e., metal form) of the metal-ions of the metal ion-conducting electrochemical device. The textured metal may have a 20% or less lattice mismatch (e.g., 10% or less, 5% or less, 4% or less, 3% or less, 2% or less, or 1% or less), which may be f, with the reduced form (i.e., metal form) of the metal-ions of the metal ion-conducting electrochemical device having, for example, a close packed plane, such as, for example, a (001) plane in hexagonal close packed structures, a (111) plane in face centered cubic structures, (110) plane in body centered cubic structures, and the like).

A textured metal can have various textures. In various examples, a textured metal exhibits exposed crystal planes that have high packing density, e.g., the close-pack plane. In various examples, a textured metal exhibits close-packed basal planes aligned horizontally with respect to the surface of the textured metal. In various examples, electrodeposition on a textured metal surface provides a relatively smooth, compact deposition morphology/microstructure.

A desired texture (of a textured metal and/or an electrodeposited layer) may be horizontally aligned close-packed basal planes with respect to the textured metal or anode surface. Such a textured surface may exhibit a desirably smooth, compact morphology/microstructure. In various examples, a textured metal comprises crystalline facets (e.g., disposed on a surface of the textured metal and available for interaction, for example, with an electrolyte of an electrochemical device) and 20% to 100% (e.g., 50%-100%, 60%-100%, or 80%-100%), including all 0.1% values and ranges therebetween, of the crystalline facets are desired crystalline facets. A desired crystal facet may be a close packed plane, such as, for example, a (001) plane in hexagonal close packed structures, a (111) plane in face centered cubic structures, (110) plane in body centered cubic structures, or the like. The percentage of desired crystalline facets may be determined by methods known in the art. In various examples, the percentage of desired crystalline facets may be determined by X-ray diffraction.

In various examples, a textured metal exhibits one or both of the following: the textured metal preferentially exposes a certain set of crystal facets, the lattice misfit between the exposed facet and an electrodeposited metal is small, i.e., less than about 20% or less than about 15%. Without intending to be bound by any particular theory, it is considered that when these conditions are met the other metal (e.g., an electrodeposited metal) can be epitaxially electrodeposited, which may be reversible, on a textured metal or anode surface.

A textured metal may comprise the same crystal structure as the metal produced by electrodeposition. It is not necessary that the textured metal has the same crystal structure as the metal produced by electrodeposition. The textured metal may comprise a different crystal structure than the metal produced by electrodeposition.

In various examples, the textured metal has the same nominal composition at the other metal (e.g., electrodeposited metal or the like). In various examples, the textured metal has the same metal atom packing arrangement (e.g., fcp, fcc, bcc, or the like) as the other metal (e.g., electrodeposited metal or the like). In an illustrative example, the textured metal is a hcp metal and the other metal (e.g., electrodeposited metal or the like) is a hcp metal. In various examples, the textured metal and the other metal (e.g., electrodeposited metal or the like) have a lattice mismatch as described herein.

In various examples, a textured metal is a layer of a textured metal disposed on at least a portion or all one or more surface(s) of a metal (which may have the same nominal composition or a different composition than the textured metal).

In various examples, a textured metal is disposed on at least a portion of a surface, which may be an exterior surface, of a metal member (e.g., all portions of the metal member that would be or are in contact with the electrolyte of the metal ion-conducting electrochemical device). In various examples, the textured metal promotes epitaxial electrodeposition, which may be reversible, of the reduced form the metal-ions of an ion-conducting electrochemical device.

In various examples, a textured metal is a metal member, and a textured layer of electrodeposited metal is disposed on at least a portion or all of a surface of the metal member. In various examples is a metal, such as, for example, iron, magnesium, molybdenum, chromium, vanadium, tungsten, or the like, or any combination thereof and/or the textured layer of electrodeposited metal is potassium, sodium, lithium, zinc, magnesium, aluminum, calcium, or the like. In various examples, the textured metal member has bcc crystal structure (e.g., metals, such as, for example, iron, magnesium, molybdenum, chromium, vanadium, tungsten, and the like) and the metal produced by electrodeposition has bcc crystal structure (e.g., metals, such as, for example, sodium, lithium, and the like). In various other examples, the textured metal member has a fcc crystal structure (e.g., metals, such as, for example, silver, gold, and the like) and the metal produced by electrodeposition has fcc crystal structure (e.g., metals, such as, for example, aluminum metal and the like).

A textured metal (or an anode comprising one or more textured metal(s)) may further comprise an electrodeposited layer disposed on at least a portion of an exterior surface of the textured metal or textured metal layer. The electrodeposited layer may be the reduced form (i.e., metal form) of the metal ions of a metal ion-conducting battery. For example, epitaxial electrodeposition is provided by a textured metal that has 20% or less lattice mismatch (e.g., 10% or less, 5% or less, 4% or less, 3% or less, 2% or less, or 1% or less), with the reduced form (i.e., metal form) of the metal-ions of the metal ion-conducting electrochemical device. When the lattice mismatch is greater than 20%, the epitaxial electrodeposition may also occur on a textured metal, which may have exposed a particular (e.g., oriented) crystal facet or plane), in which a certain crystal facet may be exposed (e.g., a close packed plane, such as, for example, a (001) plane in hexagonal close packed structures, a (111) plane in face centered cubic structures, (110) plane in body centered cubic structures, and the like). In various examples, the interface between the textured metal and electrodepostited layer is coherent or semicoherent.

The textured metal may epitaxially template deposition of the reduced form (i.e., metal form) of the metal ions of a metal ion-conducting battery. In various examples, the metal-ions lithium ions, sodium ions, potassium ions, calcium ions, magnesium ions, zinc ions, aluminum ions, iron ions, and the like and the reduced form (e.g., metal form) of the metal ions is lithium metal, sodium-metal, potassium metal, calcium metal, magnesium metal, zinc metal, aluminum metal, iron metal, and the like, respectively. The epitaxial templating may be homoepitaxial templating or heteroepitaxial templating.

An electrodeposited layer can have various thickness. The thickness may depend on, for example, battery components, conducting ion/electrodeposited metal, battery capacity, etc. In various examples, an electrodeposited layer has a thickness of about 0.1 micrometers to about 200 micrometers, including all 0.05 micrometer values and ranges therebetween. The electrodeposited layer may be uniform and/or a smooth morphology (e.g., as determined by AFM, SEM, profilometer, or the like, or a combination thereof.

In various examples, the textured metal comprises (e.g., is) a metal or metals, a metal alloy (e.g., metal alloys comprising two or more bcc metals or a fcc metal and a bcc metal), or the like, or any combinations thereof. Non-limiting examples of metals include gold, silver, indium, tin, cerium, lanthanum, thulium, zirconium, titanium, iron, and chromium, and the like. Non-limiting examples of metal alloys include any combination of gold, silver, indium, tin, cerium, lanthanum, thulium, zirconium, titanium, iron, and chromium, or the like. A metal or metal alloy may be chemically inert and/or electrochemically stable under the electrochemical cycling conditions.

A textured metal may be ordered. A textured metal may be crystalline. In various examples, a textured metal is single crystalline or polycrystalline.

At least a portion or all of an exterior surface of the textured metal (e.g., at least a portion or all portions of the textured metal that would be or are in contact with the electrolyte of the metal ion-conducting electrochemical device) may have crystal facets. In various examples, at least a portion or all of an exterior surface of the textured metal (e.g., at least a portion or all portions of the textured metal that would be or are in contact with the electrolyte of the metal ion-conducting electrochemical device) the crystal facets are a close packed plane, such as, for example, a (001) plane in hexagonal closest packed structure, a (111) plane in face centered cubic structures, (110) plane in body centered cubic structures, or the like.

A textured metal or a textured metal layer can have various thicknesses. In various examples, the thickness (e.g., a dimension perpendicular to the longest linear dimension or plane of the textured metal or a textured metal layer or the like) of the textured metal or a textured metal layer is about 10 nanometers to about 5 centimeters, including all integer nanometer values and ranges thereof therebetween. In various examples, the thickness (e.g., a dimension perpendicular to the longest linear dimension or a plane of the textured metal or a textured metal layer or the like) of the textured metal or a textured metal layer is about 0.5 micrometers to about 2 millimeters, 1 micrometer to about 5 micrometers, about 1 micrometer to about 10 micrometers, about 1 micrometer to about 50 micrometers, 1 micrometers to about 100 micrometers, about 1 micrometer to about 500 micrometers, or about 100 micrometers to about 500 micrometers.

A textured metal or a layer of a textured metal may be disposed on at least a portion of an exterior surface of a metal member. In various examples, an anode comprises or is a textured metal disposed on at least a portion of an exterior surface of a metal member. A metal member may comprise (or be) various materials. A metal member may comprise (or be) a solid metal or a metal foam. A metal member may be a current collector. The metal member may be an active metal member (e.g., the same metal as the textured metal and/or electrodeposited metal) or an inactive metal member (e.g., a different metal than the textured metal and/or electrodeposited metal). Non-limiting examples of metal members include lithium metal, sodium metal, potassium metal, calcium metal, magnesium metal, zinc metal, aluminum metal, iron metal, stainless steel, copper metal (e.g., copper foil or the like), or the like.

A textured metal may be disposed on at least a portion of an exterior surface of a metal member may have one or more desirable property(ies). In various examples, the textured metal exhibits a conductivity of 101 to 109 S/m, including all integer S/m values and ranges therebetween, the textured metal is electrochemically stable against anode reaction(s) and/or electrolyte chemistry, the textured metal has a desirable lattice misfit with an/or similar crystal symmetry to an electrodeposited metal, or any combination thereof.

A textured metal can have various forms and/or sizes. In various examples, a textured metal is a foil, a monolith, strip, ribbon, or the like. The size of a textured metal is not particularly limited. In various examples, a textured metal has a size (one or more or all dimension(s) suitable for use in an electrochemical device, such as, for example, a battery, which may be a reversible battery, or the like.

In an aspect, the present disclosure provides anodes. An anode comprises one or more textured metal(s) of the present disclosure. A portion or all of the textured metal(s) may be epitaxial textured metal(s). The anode may be a reversible anode. In various examples, one or more or all of textured metal(s) is/are made by a method of the present disclosure. Non-limiting examples of anodes are provided herein.

In various examples, an anode is textured metal. In various examples, an anode comprises a metal member that is a textured metal and a textured layer of electrodeposited metal (which may be textured) disposed on at least a portion or all of a surface of the metal member.

In various examples, the anode(s) are part of secondary batteries or secondary cells, which may be rechargeable batteries. Non-limiting examples of secondary batteries and primary batteries include Li-ion batteries, Li metal batteries, sodium-ion batteries, sodium-metal batteries, and the like. In various examples, an anode does not exhibit substantial or any observable metal orphaning. In various examples, an anode does not comprise a binder.

An anode may comprise a current collector other than the textured metal(s) and/or metal member(s)). In an example, an anode does not comprise a metal current collector. The textured metal(s) may be disposed on a current collector (e.g., a metal current collector). The anode may be free of other conducting materials (e.g., carbon-based conducting materials and the like).

An anode may promote epitaxial electrodeposition, which may be reversible, of the reduced form the metal-ions of an ion-conducting electrochemical device. A textured metal may comprise (or be) the same metal as the electrodeposited metal. In this case, the electrodeposition is referred to homoepitaxial electrodeposition. A textured metal may comprise (or be) a different material than electrodeposited metal. In this case, the electrodeposition is referred to heteroepitaxial electrodeposition. For example, epitaxial electrodeposition is provided by a textured metal that has 20% or less lattice mismatch (e.g., 10% or less, 5% or less, 4% or less, 3% or less, 2% or less, or 1% or less), with the reduced form (i.e., metal form) of the metal-ions of the metal ion-conducting electrochemical device. When the lattice mismatch is greater than 20%, the epitaxial electrodeposition may also occur on a textured conductive coating, which may have exposed a particular (e.g., oriented) crystal facet or plane), in which a certain crystal facet may be exposed. (e.g., a close packed plane, such as, for example, a (001) plane in hexagonal close packed structures, a (111) plane in face centered cubic structures, (110) plane in body centered cubic structures, and the like). The anode may epitaxially (e.g., homoepitaxially or heteroepitaxially) template deposition of the reduced form (i.e., metal form) of the metal-ions of the metal ion-conducting electrochemical device.

In an aspect, the present disclosure provides devices. A device comprises one or more textured metal(s) and/or one or more metal anode(s). A device may exhibit epitaxial electrodeposition (e.g., homoepitaxial electrodeposition or heteroepitaxial deposition) of the metal form of the conducting ions of the device. Non-limiting examples of devices are provided herein.

A device may be an electrochemical device. Non-limiting examples of electrochemical devices include batteries, supercapacitors, fuel cells, electrolyzers, electrolytic cells, and the like.

A device can be various batteries. Non-limiting examples of batteries include secondary/rechargeable batteries, primary batteries, and the like. A battery may be an ion conducting battery. Non-limiting examples of ion-conducting batteries include lithium-ion conducting batteries, potassium-ion conducting batteries, sodium-ion conducting batteries, magnesium-ion conducting batteries, aluminum-ion conducting batteries, iron-ion conducting batteries, and the like. A battery may be a metal battery, such as, for example, a lithium-metal battery, a sodium-metal battery, magnesium-metal battery, or the like. A device may be a solid-state battery or a liquid electrolyte battery.

In the case of a device, which may be a battery, comprising an anode material or anode of the present disclosure, the device may comprise one or more cathode(s), which may comprise one or more cathode material(s). Examples of suitable cathode materials are known in the art. In various examples, the cathode material(s) is/are one or more lithium-containing cathode material(s), one or more potassium-containing cathode material(s), one or more sodium-containing cathode material(s), one or more magnesium-containing cathode material(s), one or more aluminum-containing cathode material(s), or the like. Examples of suitable cathode materials are known in the art. Non-limiting examples of lithium-containing cathode materials include lithium nickel manganese cobalt oxides, LiCoO₂, LiNi_{1/3}CO_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and combinations thereof, and the like, and combinations thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and combinations thereof. Non-limiting examples of magnesium-containing cathode materials include magnesium-containing materials (such as, for example, MgMSiO₄ (M is Fe, Mn, or Co) materials and MgFePO₄F materials, and the like), FeS₂ materials, MoS₂ materials, TiS₂ materials, and the like. Any of these cathodes/cathode materials may comprise a conducting carbon aid.

The device, which may be a battery, may comprise a conversion-type cathode. Non-limiting examples of conversion-type cathode materials include air (e.g., oxygen), iodine, sulfur, sulfur composite materials, polysulfides, metal sulfides, such as, for example, MoS₂, FeS₂, TiS₂, and the like, and combinations thereof.

A device, which may be a battery, may further comprise a solid electrolyte or liquid electrolyte. It may be desirable that the electrolyte by non-flammable (e.g., a non-flammable aqueous electrolyte). Examples of suitable electrolytes are known in the art.

A device may further comprise a current collector disposed on at least a portion of the anode(s). In various examples, the current collector is a conducting metal or metal alloy.

An electrolyte, a cathode, an anode, and, optionally, the current collector may form a cell of a battery. The battery may comprise a plurality of the cells and each adjacent pair of the cells is separated by a bipolar plate. The number of cells in the battery is determined by the performance requirements (e.g., voltage output and the like) of the battery and is limited only by fabrication constraints. For example, the battery comprises 1 to 500 cells, including all integer number of cells and ranges therebetween.

A metal-ion conducting secondary/rechargeable battery may comprise one or more conducting(s). A battery may further comprise an aqueous or non-aqueous electrolyte. The coating(s) may exhibit epitaxial relation with an electrochemically deposited metal.

In various examples, a battery is a zinc-ion conducting secondary/rechargeable battery comprising one or more textured metal(s) (e.g., one or more anode(s) of the present disclosure comprising one or more textured metal(s)) and an aqueous electrolyte. In various examples, the textured metal(s) are independently at each occurrence zinc or the like.

A battery may have one or more desirable property(ies). In various examples, a battery exhibits at least 1,000, at least 2,500, at least 5,000, at least 7,500, or at least 10,000 charging/discharging cycles without failure; does not exhibit detectible dendritic growth and/or orphaning; exhibits one or more or all charging/discharging cycle(s), for example, for 1,000 cycles or greater, 2500 cycles or greater, 5,000 cycles or greater, 7,500 cycles or greater, or cycles or greater and/or at rate of 40 mA/cm² or greater; or any combination thereof.

In an aspect, the present disclosure provides methods of operating an electrochemical device. The methods provide an electrochemically deposited layer of a metal formed by the reduction of the metal-ions of the metal-ion conducting electrochemical device.

In various examples, during an epitaxial electrodeposition process at an anode of the present disclosure, which may be present in an electrochemical device, such as, for example, a battery or the like, an electrochemically inactive substrate with the right crystal symmetry and lattice parameters would, upon charging, facilitate the homoepitaxial or heteroepitaxial nucleation and growth of the electrochemically active metal in a strain-free or substantially strain-free state. Once the active metal nucleates cover the surface of the substrate, the as-deposited metal layer would then serve as the new substrate that facilitates subsequent self-templated, homoepitaxial deposition to create large and uniform metal coatings at the electrode. Upon discharging, the metal is stripped away while the electrochemically inactive substrate remains intact and therefore available for a subsequent cycle of charge and discharge.

In an example, an electrochemical device is under current flow and an electrochemically deposited layer of a metal formed by the reduction of the metal-ions of the metal-ion conducting electrochemical device is formed on at least a portion of the surface(s) of the textured metal(s) of the electrochemical device. The electrochemically deposited layer may be reversibly formed. In various examples, the electrochemically deposited layer is reversibly formed (e.g., under charging/discharging conditions), at least 1,000, at least 2,500, at least 5,000, at least 7,500, or at least 10,000 times without failure. The interface between the textured metal and electrodeposited layer may be coherent or semicoherent. In the case where the electrodeposited layer is formed multiple times, at least a portion or all of the interfaces between the textured metal and electrodeposited layer may, independently, be coherent or semicoherent.

In various examples, an electroactive metal layer is plated (deposited) and/or stripped (dissolved) uniformly on a textured metal of an electrochemical device. Without intending to be bound by any particular theory, it is considered the electroactive metal layer plating (depositing) and/or stripping (dissolving) is stabilized by the textured metal of an electrochemical device. In various examples, an electrochemical device exhibits uniform and compact deposition of a metal (e.g., an electroactive metal or the like) and/or dissolution of a metal (e.g., an electroactive metal or the like).

The following Statements provide examples of textured metals, anodes, devices, and methods of the present disclosure:
Statement 1. A method of making a textured metal or a textured metal layer (e.g., a metal comprising an exterior layer of a textured metal) comprising: rolling a metal (e.g., a metal, a metal alloy, or the like); and folding the rolled metal.
Statement 2. A method according to Statement 1, wherein the rolling and folding are repeated until a desired texture is obtained and/or from 1 to 20 times.
Statement 3. A method according to Statements 1 or 2, wherein the metal is a metal foil.
Statement 4. A method according to any one of the preceding Statements, wherein the rolling results in severe plastic deformation (SPD) of the metal.
Statement 5. A method according to any one of the preceding Statements, wherein the rolling results in plastic flow of the metal.
Statement 6. A method according to any one of the preceding Statements, wherein the rolling results in anisotropic deformation(s) (e.g., plane-shear, elongation, or the like, or any combination thereof) of the metal.
Statement 7. A method according to any one of the preceding Statements, wherein the rolling results in plastic flow of the metal.
Statement 8. A method according to any one of the preceding Statements, wherein the rolling results in anisotropic deformation(s) (e.g., plane-shear, elongation, or the like, or any combination thereof) of the metal.
Statement 9. A method according to any one of the preceding Statements, wherein the rolling results in alignment of one or more slip plane(s) of the metal (e.g., and results in formation of a desired texture).
Statement 10. A method according to any one of the preceding Statements, wherein the alignment occurs preferentially between one or more or all of close packed plane(s) of the metal.
Statement 10. A method according to any one of the preceding Statements, wherein the rolling results in alignment of one or more slip plane(s) of the metal (e.g., and results in formation of a desired texture) along a particular direction the metal.
Statement 11. A method according to any one of the preceding Statements, wherein the slip occurs preferentially at one or more or all (002) plane(s) (which may be along one or more or all <110> directions) in a hexagonal close packed metal, preferentially at one or more or all (110) plane(s) in a body-centered cubic (bcc) metal, or preferentially at one or more or all (111) plane(s) in a face centered cubic metal.
Statement 12. A method according to any one of the preceding Statements, wherein each rolling is carried out at a temperature of about 0.3 to about 0.99 of the melting temperature (Tₘ) of the metal, including all 0.01 values and ranges therebetween.
Statement 13. A method according to any one of the preceding Statements, wherein each folding is a bonding.
Statement 14. A method according to any one of the preceding Statements, wherein each folding is folding the metal in half.
Statement 15. A method according to any one of the preceding Statements, wherein the metal is (or comprises) a hexagonal close packed metal, a body centered cubic metal, a face centered cubic metal, or the like.
Statement 16. A method according to any one of the preceding Statements, wherein the metal exhibits a homologous temperature (T_{H}) of greater than or equal to about 0.4.
Statement 17. A method according to any one of the preceding Statements, wherein the metal is a metal foil or the like.
Statement 18. A method according to any one of the preceding Statements, wherein the metal comprises a thickness of about 10 nanometers to about 5 centimeters (about 0.5 micrometers to about 2 millimeters or 1 micrometers to about 100 micrometers or about 1 micrometer to about 500 micrometers), including all integer nanometer values and ranges thereof therebetween.
Statement 19. A method according to any one of the preceding Statements, wherein the metal comprises (or is) potassium, sodium, lithium, zinc, magnesium, aluminum, calcium, or the like, or any combination thereof.
Statement 20. A method according to any one of the preceding Statements, wherein the textured metal or textured metal layer comprises (or exhibits) a texture described herein (e.g., a texture described in Table 2 of Example 1, or the like).
Statement 21. An anode, which may be for a metal ion-conducting electrochemical device, comprising (consisting essentially of or consisting of) a metal member; a textured metal, which may be an epitaxial textured metal, disposed on at least a portion of the metal member (e.g., all portions of the metal member that would be or are in contact with the electrolyte of the metal ion-conducting electrochemical device). The textured metal may promote epitaxial electrodeposition, which may be reversible, of the reduced form the metal-ions of an ion-conducting electrochemical device. For example, epitaxial electrodeposition is provided by a textured metal that has 20% or less lattice mismatch (e.g., 10% or less, 5% or less, 4% or less, 3% or less, 2% or less, or 1% or less), with the reduced form (i.e., metal form) of the metal-ions of the metal ion-conducting electrochemical device. When the lattice mismatch is greater than 20%, the epitaxial electrodeposition may also occur on a textured conductive coating, which may have exposed a particular (e.g., oriented) crystal facet or plane), in which a certain crystal facet may be exposed (e.g., a close packed plane, such as, for example, a (001) plane in hexagonal close packed structures, a (111) plane in face centered cubic structures, (110) plane in body centered cubic structures, and the like).
Statement 22. An anode of Statement 21, wherein the textured metal epitaxially (e.g., homoepitaxially or heteroepitaxially) templates deposition of the reduced form (i.e., metal form) of the metal-ions of a metal ion-conducting electrochemical device. The interface between the textured metal and electrodepostited layer may be coherent or semicoherent.
Statement 23. An anode according to Statement 21 or 22, wherein the textured metal comprises (e.g., is) a metal or a metal alloy (e.g., between two or more bcc metals or a fcc metal and a bcc metal, where the alloy is chemically inert and/or electrochemically stable under the electrochemical cycling conditions), or intermetallic compound, or a combination thereof.
Statement 24. An anode according to Statement 23, wherein the textured metal is a metal (e.g., gold, silver, zirconium, titanium, iron, chromium, or the like).
Statement 25. An anode according to Statement 23, wherein the textured metal is a metal alloy (e.g., a metal alloy of any combination of gold, silver, zirconium, titanium, iron, chromium, or the like, or any combination thereof.
Statement 26. An anode according to any one of Statements 21-25, wherein the textured metal is crystalline (e.g., single-crystalline).
Statement 27. An anode according to any one of Statements 21-26, wherein at least a portion or all of an exterior surface of the metal member (e.g., at least a portion or all portions of the metal member that would be or are in contact with the electrolyte of the metal ion-conducting electrochemical device) have crystal facets (e.g., a close packed plane, such as, for example, a (001) plane in hexagonal closest packed structure, a (111) plane in face centered cubic structures, (110) plane in body centered cubic structures, and the like and/or 20% to 100% (e.g., 50%-100%, 60%-100%, 70-100%, or 80%-100%), including all 0.1% values and ranges therebetween, of the crystalline facets are the desired crystalline facets.)
Statement 28. An anode according to any one of Statements 21-27, wherein the thickness of the textured metal is about 10 nanometers to about 5 centimeters, including all integer nanometer values and ranges thereof therebetween.
Statement 29. An anode according to any one of Statements 21-28, wherein the textured metal has a conductivity of 10¹ to 10⁹ S/m, including all integer S/m values and ranges therebetween.
Statement 30. An anode according to any one of Statements 21-29, wherein the textured metal is made by a method of the present disclosure.
Statement 31. An anode according to any one of Statements 21-30, wherein the metal-ions of the metal ion-conducting electrochemical device are lithium ions, sodium ions, potassium ions, calcium ions, magnesium ions, zinc ions, aluminum ions, iron ions, or the like.
Statement 32. An anode according to any one of Statements 21-31, wherein the metal member (which may be an active metal member (e.g., the same metal as the electrodeposited metal) or an inactive metal member (e.g., a different metal than the electrodeposited metal)) is lithium metal, sodium metal, potassium metal, calcium metal, magnesium metal, zinc metal, aluminum metal, iron metal, stainless steel, copper metal (e.g., copper foil), or the like. A metal member may comprise (or be) a solid metal or a metal foam.
Statement 33. A device comprising one or more anode(s) of the present disclosure (e.g., one or more anode(s) of any one of Statements 21-32 and/or one or more anode(s) made by a method of the present disclosure (e.g., made by a method/methods of any of Statements 1-20).
Statement 34. A device according to Statement 33, wherein the device is an electrochemical device. The conduction process of the electrochemical device may involve reduction of metal ions to form a metal and oxidation of that metal to form metal ions.
Statement 35. A device according to Statement 34, wherein the electrochemical device is a battery (e.g., a secondary/rechargeable battery, a primary battery, and the like), a supercapacitor, a fuel cell, an electrolyzer, an electrolytic cell, or the like.
Statement 36. A device according to Statement 35, wherein the battery is an ion-conducting battery (e.g., a metal-ion conducting battery).
Statement 37. A device according to Statement 36, wherein the ion-conducting battery is a lithium-ion conducting battery, a potassium-ion conducting battery, a sodium-ion conducting battery, a calcium-ion conducting battery, a magnesium-ion conducting battery, a zinc-ion conducting battery, an aluminum-ion conducting battery, iron-ion conducting battery, or the like.
Statement 38. A device according to any one of Statements 35-37, wherein the battery further comprises a cathode (e.g., a cathode comprising a conversion material or intercalation material) and/or one or more electrolyte(s) and/or, optionally, one or more current collector(s) and/or, optionally, one or more additional structural component(s). Examples of conversion materials and intercalation materials are known in the art.

Statement 39. A device according to Statement 38, wherein the electrolyte is a liquid electrolyte or solid-state electrolyte.
Statement 40. A device according to Statement 39, wherein the liquid electrolyte is an aqueous electrolyte or a non-aqueous electrolyte (e.g., carbonate-based electrolytes, ether-based electrolytes, or the like, or combinations thereof).
Statement 41. A device according to any one of Statements 38-40, wherein the one or more additional structural component(s) is/are chosen from bipolar plates, external packaging, and electrical contacts/leads to connect wires, and combinations thereof.
Statement 42. A device according to any one of Statements 35-41, wherein the battery comprises a plurality of cells, each cell comprising one or more electrode (e.g., one or more cathode and/or anode) or one or more electrode material (e.g., one or more cathode material and/or anode material), and optionally, one or more anode(s), electrolyte(s), current collector(s), or a combination thereof.
Statement 43. A device according to Statement 24, wherein the battery comprises 1 to 500 cells.
Statement 44. A device according to any one of Statement 34-43, wherein device is configured so that the conducting metal ions electrodeposit (e.g., reversibly electrodeposit) on at least a portion or all of the surface of the textured metal in contact with the electrolyte forming a metal layer (e.g., an electrochemically deposited layer) comprising one or more crystalline domains or a crystalline metal layer.
Statement 45. A device according to Statement 44, wherein the electrochemically deposited metal layer has low surface area and/or high density. The density of the epitaxially deposited metal may be bulk metal density or substantially bulk metal density (e.g., within 5% or less, 4% or less, 3% or less, 2% or less, 1% or less, or 0.1% or less of bulk density).
Statement 46. A device according to Statement 44 or 45, wherein the electrochemically deposited metal layer comprises metal layers, which may be uniform.

Statement 47. A device according to any one of Statements 35-46, wherein battery exhibits one or more of the following: the battery does not exhibit detectible (e.g., detectible by imaging techniques, such as, for example, SEM, TEM, and the like) dendritic growth (e.g., dendritic growth pattern) and/or orphaning.
Statement 48. A method of making a textured metal or a textured metal layer (e.g., a metal comprising an exterior layer of a textured metal) comprising: rolling a metal (e.g., a metal, a metal alloy, or the like); and folding the rolled metal.
Statement 49. The method of claim 48, wherein the rolling and folding are repeated from 1 to 20 (e.g., 1, 2, 3, 4, 5, 6, 7, 8, 9, 10, 11, 12, 13, 14, 15, 16, 17, 18, 19, or 20) times.
Statement 50 The method of claim 48 or 49, where the metal is a metal foil, a metal film, a metal ribbon, a metal strip, a metal tape, or the like.
Statement 51. The method of any one of Statements 48-50, where the rolling results in severe plastic deformation (SPD) of the metal.
Statement 52. The method of any one of Statements 48-51, where the rolling results in plastic flow of the metal.
Statement 53. The method of any one of Statements 48-52, where the rolling results in anisotropic deformation(s) (e.g., plane-shear, elongation, or the like, or any combination thereof) of the metal.
Statement 54. The method of Statements 53, wherein the anisotropic deformation(s) are in plane-shear, elongation, or the like, or any combination thereof.
Statement 55. The method of any one of Statements 48-54, where the rolling results in alignment of one or more slip plane(s) of the metal (e.g., and results in formation of a desired texture).
Statement 56. The method of Statement 55, where the alignment occurs preferentially between one or more or all of close packed plane(s) of the metal.
Statement 57. The method of any one of Statements 48-56, wherein the rolling results in alignment of one or more slip plane(s) of the metal (e.g., and results in formation of a desired texture) along a particular direction the metal.
Statement 58. The method of Statement 57, where the alignment occurs preferentially of one or more or all (002) plane(s) (which may be along one or more or all <110> directions) in a hexagonal close packed metal, preferentially at one or more or all (110) plane(s) in a body-centered cubic (bcc) metal, or preferentially at one or more or all (111) plane(s) in a face centered cubic metal.
Statement 59. The method of any one of Statements 48-58, where each rolling is carried out at a temperature of about 0.3 to about 0.99 of the melting temperature (Tₘ) of the metal, including all values and ranges therebetween.
Statement 60. The method of any one of Statements 48-59, where each folding is a bonding.
Statement 61. The method of any one of Statements 48-60, where each folding is folding the metal in half.
Statement 62. The method of any one of Statements 48-61, where the metal is (or comprises) a hexagonal close packed metal, a bcc metal, or a fcc metal, or the like.
Statement 63. The method of any one of Statements 48-62, where the metal exhibits a homologous temperature (T_{H}) of greater than or equal to about 0.4.
Statement 64. The method of any one of Statements 48-63, where the metal is a metal foil or the like.
Statement 65. The method of any one of Statements 48-64, where the metal comprises a thickness of about 10 nanometers to about 5 centimeters.
Statement 66. The method of any one of Statements 48-65, where the metal comprises (or is) potassium, sodium, lithium, zinc, magnesium, aluminum, calcium, or the like, or any combination thereof.
Statement 67. The method of any one of Statements 48-50, where the textured metal or textured metal layer comprises (or exhibits) a texture described herein (e.g., a texture described in Table 2 of Example 1, or the like).
Statement 68. An anode comprising: i) a textured metal, or ii) a metal member (which may be a textured metal); and a textured metal disposed on at least a portion of the metal member, where, optionally, the textured metal can epitaxially template deposition of the reduced form of metal-ions of a metal ion-conducting electrochemical device, and/or the textured metal is chemically inert and/or electrochemically stable under electrochemical cycling conditions.
Statement 69. The anode of Statement 68, where the textured metal comprises (or is) a metal, a metal alloy, or the like.
Statement 70. The anode of Statement 68 or 69, where the textured metal is a metal member and comprises a metal chosen from gold, silver, zirconium, titanium, iron, chromium, and the like, and combinations thereof.
Statement 71. The anode of any one of Statements 68-70, where the textured metal is potassium, sodium, lithium, zinc, magnesium, aluminum, calcium, or the like, or any combination thereof.
Statement 72. The anode of any one of Statements 68-71, where the textured metal is crystalline.
Statement 73. The anode of any one of Statements 68-72, where wherein at least a portion or all of an exterior surface of the textured metal comprises crystal facets chosen from a (001) plane in hexagonal closest packed structure, a (111) plane in face centered cubic structure, and a (110) plane in body centered cubic structure.
Statement 74. The anode of claim 73, where 80%-100% of the crystal facets of the textured metal are a (001) plane in hexagonal closest packed structure, a (111) plane in face centered cubic structure, or a (110) plane in body centered cubic structure.
Statement 75. The anode of any one of Statements 68-74, where the thickness of the textured metal is about 10 nanometers to about 5 centimeters.
Statement 76. The anode of any one of Statements 68-75, where the textured metal has a conductivity of 10¹ to 10⁹ S/m.
Statement 77. The anode of any one of Statements 68-76, where the metal member is an active metal member or an inactive metal member.
Statement 78. A device comprising one or more anode(s) of the present disclosure (e.g., anode(s) of any one of Statements 68-77) and/or or one or more anode(s) made by a method of the present disclosure (e.g., anode(s) made by a method of any of Statements 48-67).
Statement 79. The device of claim 78, where the device is an electrochemical device.
Statement 80. The device of Statement 79, wherein the electrochemical device is a battery, a supercapacitor, a fuel cell, an electrolyzer, or an electrolytic cell.
Statement 81. The device of Statement 80, wherein the battery is a metal ion-conducting battery.
Statement 82. The device of Statement 81, where the ion-conducting battery is a lithium-ion conducting battery, a potassium-ion conducting battery, a sodium-ion conducting battery, a calcium-ion conducting battery, a magnesium-ion conducting battery, a zinc-ion conducting battery, an aluminum-ion conducting battery, or an iron-ion conducting battery.
Statement 83. The device of any one of Statements 78-82, where the battery further comprises one or more cathode(s) and/or one or more electrolyte(s) and/or, optionally, one or more current collector(s) and/or, optionally, one or more additional structural component(s).
Statement 84. The device of Statement 83, where the electrolyte is a liquid electrolyte or solid-state electrolyte.
Statement 85. The device of Statement 84, wherein the liquid electrolyte is an aqueous electrolyte or a non-aqueous electrolyte.
Statement 86. The device of any one of Statements 83-85, where the one or more additional structural component(s) is/are chosen from bipolar plates, external packaging, and electrical contacts/leads to connect wires, and combinations thereof.
Statement 87. The device of any one of Statements 80-86, where the battery comprises a plurality of cells, each cell comprising a cathode, an anode, and optionally, an electrolyte, a current collector, or a combination thereof.
Statement 88. The device of any one of Statements 80-87, where the battery comprises 1 to 500 cells.
Statement 89. The device of any one of Statements 80-88, where the battery exhibits one or more of the following: the battery does not exhibit detectible dendritic growth and/or orphaning (e.g., exhibits at least about 1,000, at least about 2,500, at least about 5,000, at least about 7,500, or at least about 10,000 charging/discharging cycles); and/or a battery exhibits at least 1,000, at least 2,500, at least 5,000, at least 7,500, or at least 10,000 charging/discharging cycles without failure; and/or an areal capacity of about 0.5 to about 50 mAh/cm² (e.g., at a current density of about 0.1 to about 100 mA/cm²); and/or an N:P ratio of about 0 to about 10; and/or a current density of about 0.1 to about 100 mA/cm².

The steps of the methods described in the various embodiments and examples disclosed herein are sufficient to produce a textured metal, an anode, or device, or carry out a method of the present disclosure. Thus, in an embodiment, a method consists essentially of a combination of the steps of the methods disclosed herein. In another embodiment, a method consists of such steps.

The following Example is presented to illustrate the present disclosure. The Example is not intended to be limiting in any manner.

### Example

This example provides a description of textured metals, anodes, devices of the present disclosure, and uses thereof.

Textured Electrodes: Manipulating built-in crystallographic heterogeneity of metal electrodes via Severe Plastic Deformation. We manipulated the built-in crystallographic properties of metal anode to illustrate the effect of the formed, textured materials, on morphological control during battery cycling. We developed an accumulative roll bonding (ARB) methodology—a severe plastic deformation process—that uses commercial metal foils as input. We demonstrated that the ARB process is highly effective in achieving uniform, mono-domain quality crystallographic control on macroscopic materials. After the ARB process, the Zn grains exhibit a strong (002) texture (i.e. [002]Zn//ND). We report further that the texture transitions from a classical bipolar pattern to a nonclassical unipolar pattern under large nominal strain, almost completely eliminating the orientational heterogeneity of the foil. Evaluated as anodes in aqueous Zn coin cells, the strongly (002)-textured Zn suppresses the rough plating/stripping landscape, promotes uniform, homoepitaxial growth of Zn and remarkably improve the continuous plating/stripping performance by nearly two orders of magnitude under practical conditions (e.g., 4 mAh at 40 mA/cm²). The performance improvements were readily scaled to achieve pouch-type Zn full batteries that deliver exceptional reversibility. The ARB process is thermo-mechanical and it is expected this method can be applied to any metal chemistry to achieve similar crystallographic uniformity, provided the appropriate temperature and accumulated strains are employed to achieve severe levels of plastic deformation. We evaluated this concept using ARB to induce strong texturing phenomena in commercial Li and Na foils, which unlike Zn (HCP) are BCC crystals, and demonstrate its success using morphological and electrochemical analysis of these metals as electrodes. Our simple process for creating strong textures in both hexagonal and cubic metals and illustrated the important role such built-in crystallography plays underscores potentially transformative opportunities for developing scalable, highly reversible thin metal anodes (e.g., hexagonal Zn, Mg, and cubic Li, Na, Ca, Al) with specific crystal textures for next generation batteries that have practical N:P ratios.

TABLE 1
Temperature design of the plastic deformation process
for candidate metals for battery anode applications.

| Metal | Melting point Tₘ (K) | 0.4 Tₘ (K) | T_{H} at RT |
|---|---|---|---|
| K | 337 | 135 | 0.88 |
| Na | 371 | 148 | 0.80 |
| Li | 454 | 182 | 0.66 |
| Zn | 693 | 177 | 0.43 |
| Mg | 923 | 369 | 0.32 |
| Al | 933 | 373 | 0.32 |
| Ca | 1115 | 446 | 0.27 |

TABLE 2
Examples of common rolling textures of metals.

| Lattice | Texture (//ND) |
|---|---|
| FCC | [111] |
| (e.g., Al, Ca) | [110] |
| | [112] |
| | [001] |
| BCC | [001] |
| (e.g., Li, Na, K) | [111] |
| | [110] |
| | [112] |
| HCP | [001] |
| (e.g., Zn, Mg) | [100] |
| | [110] |

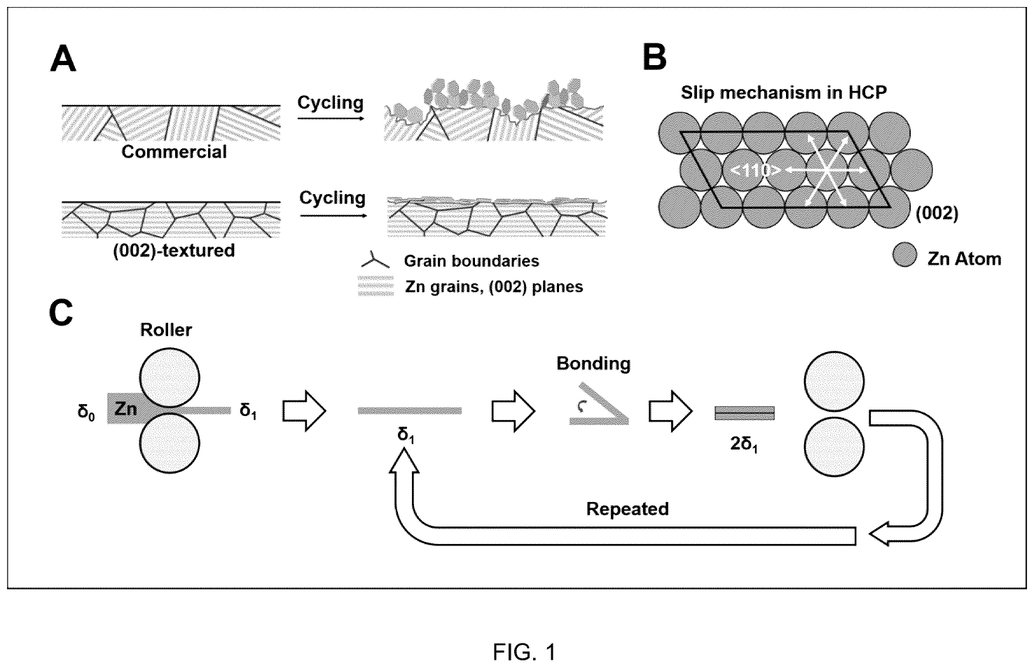

Severe plastic deformation (SPD) is a class of metallurgical processes in which a solid material is subject to a stress large enough to initiate plastic flow. An important aspect of SPD is that crystals undergo substantial texture evolution in an SPD process (see FIG. 1). SPD-induced texturing also exhibits strong dependence on the specific deformation procedures and the intrinsic crystal symmetry. This dependence is largely determined by the relative orientation of the principal deformation axis to the allowed slip planes for the material in question. The most conventional are cases where slip occurs preferentially at close-packed planes along the close-packed directions, e.g., (002) plane along <110> directions in hexagonal close packed (HCP) metals. This slip mechanism in HCP metals results in a characteristic texture of Normal Direction (ND)<002>, also referred to as (002) fiber texture. Of particular note is that, while texture evolution under plastic flow is a well-known effect, how to drive the material into a singly textured regime remains an open question. One possibility is to exert greater strains by repeatedly rolling and folding the metal, also known as accumulative roll bonding (ARB, see FIG. 1)—an advanced metallurgical technology. This ARB process will allow arbitrarily large and temperature-dependent strains to be applied cumulatively to the material. In addition to this crystallographic aspect, the rolling-based plastic deformation also provides an approach for precisely manipulating the thickness of a metal foil (down to 10 microns). This serves as a knob to fine control over the amount of metal stored in the anode chamber, and thereby achieve N:P ratios of interest in commercially-relevant cell configurations.

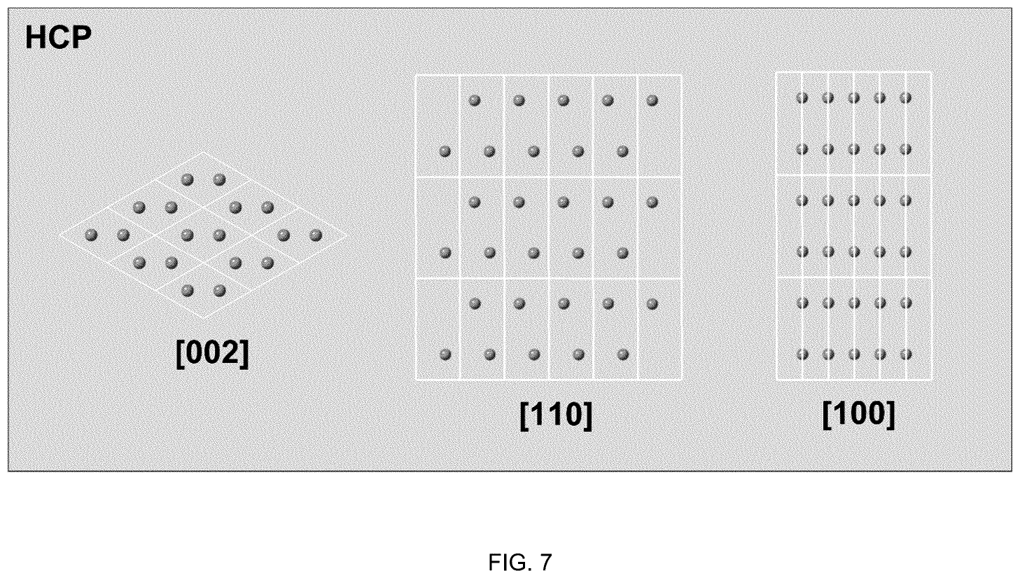

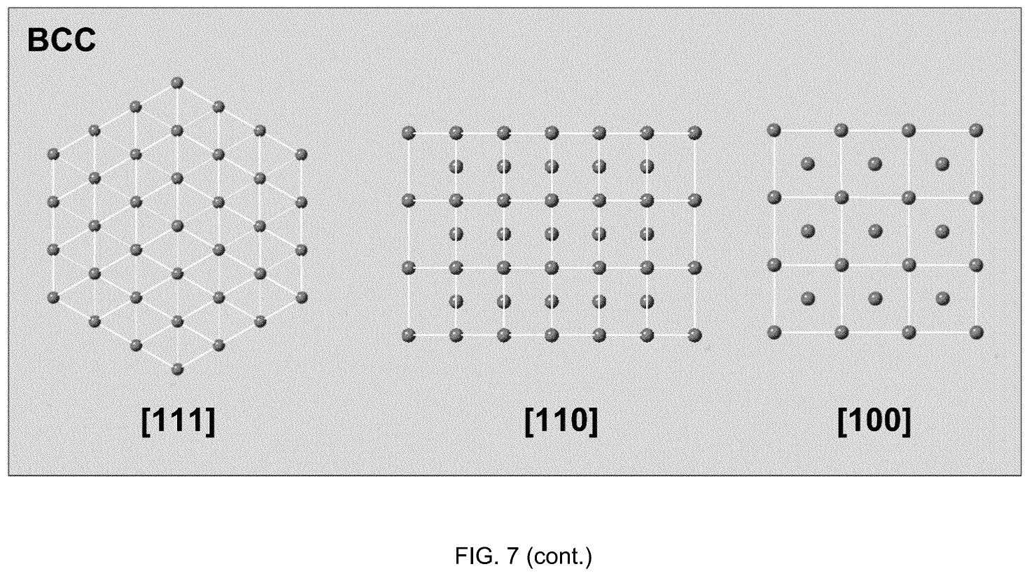

As a first demonstration, we selected Zn metal—a low-cost anode material that underpins multiple technological advances towards commercially-competitive energy storage systems—to evaluate the roles played by crystallographic heterogeneity in electro-plating/stripping. The main rationale for choosing Zn is that it has an HCP crystal structure (see FIG. 7), which is thought to correlate with a more anisotropic energy landscape than cubic crystals such as Li, Na, Al, etc. A highly anisotropic energy landscape of Zn should also impose more explicit effects on the deposition morphology. Zn therefore serves as the appropriate candidate to evaluate the roles crystallographic heterogeneity plays on the reversibility of plating and stripping processes inside a battery. A second, perhaps more tactical reason is that Zn due to its moderate electrochemical potential does not suffer from parasitic chemical reactions as serious as highly reactive alkali metals. This allows us to stay away from complications such as the formation of a solid-electrolyte interphase, and to focus on the crystallographic aspects. Finally, from a metallurgical perspective, Zn has a relatively low melting temperature (Tₘ) of 419.5° C. As a result, the homologous temperature (T_{H}) of Zn at room temperature is above 0.4 (i.e. T_{H}>0.4). This means that moderate ductility and softness is expected in Zn at room temperature, and high temperatures are therefore not required for Zn in order to avoid brittle cracking during rolling. This technical convenience greatly strengthens the technological impact the proposed concept could generate immediately. In Table 1, we summarized the temperature criteria that can be used to design deformation protocols for other metal anodes of battery interest. As an empirical rule, it is generally accepted that plastic flow could be developed when T_{H}>˜0.4.

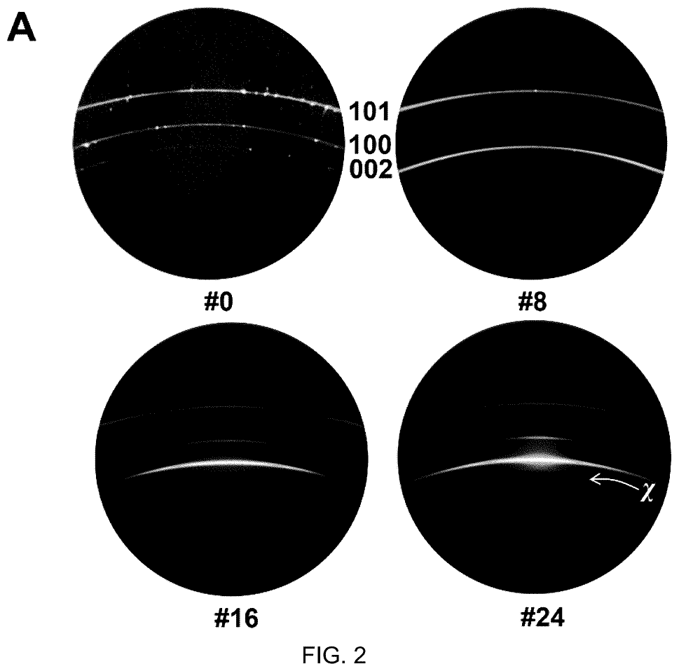

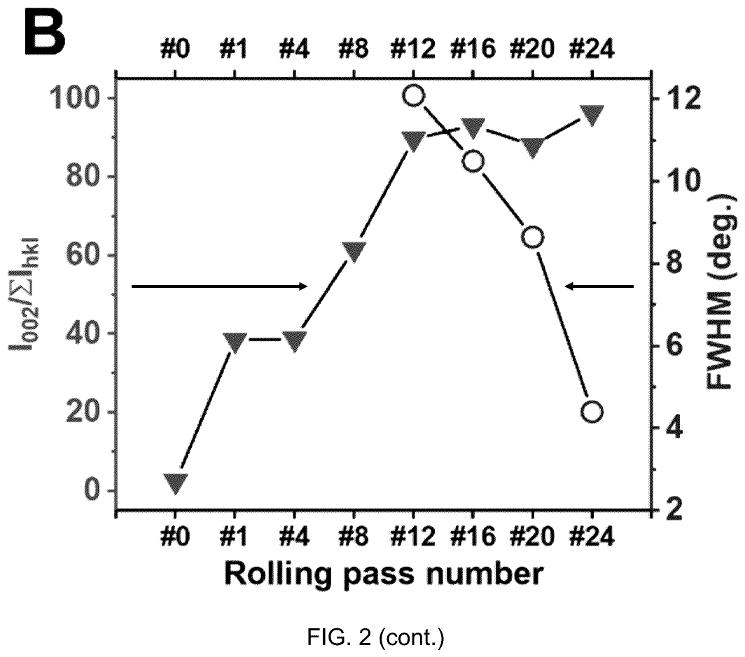

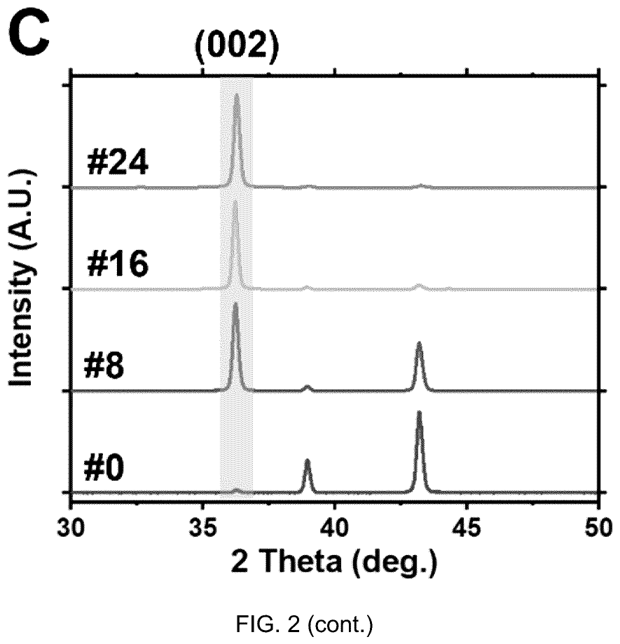

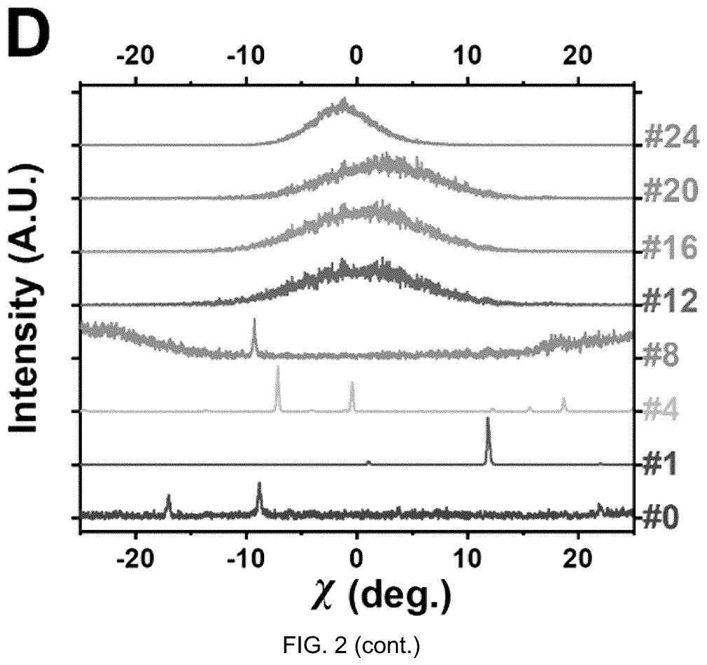

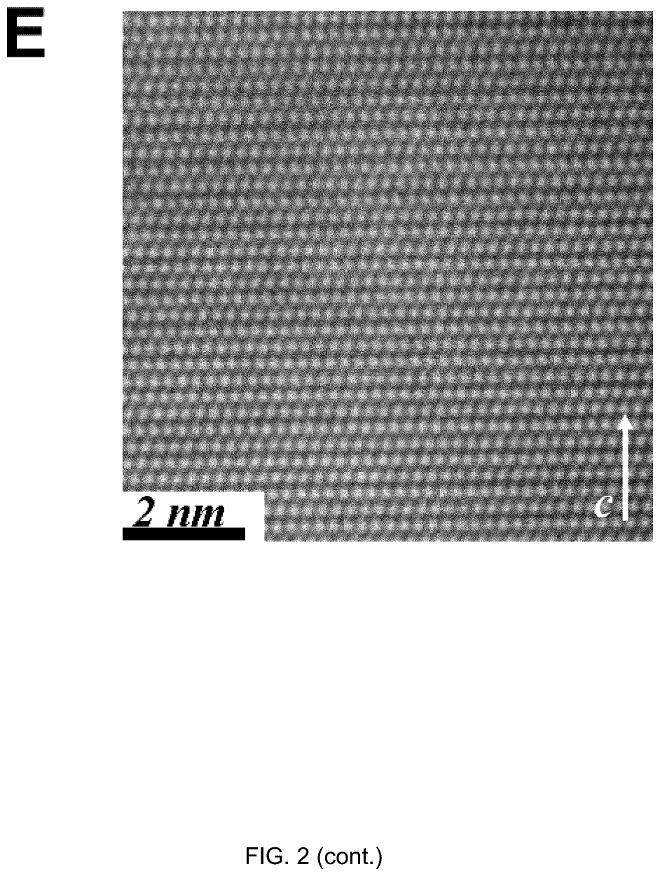

FIG. 2 reports the two-dimensional x-ray diffraction characterization of the crystallographic features under different reduction rates (i.e. after different rolling passes). As is evident in FIG. 2A, the commercial Zn metal foil shows a broad size and orientation distribution. Three main diffraction rings are assigned to (002), (100) and (101), respectively. The simultaneous presence of the three rings (at the three 2θ angles) and the random χ angles of the spots on the rings together suggests a high degree of orientational disorder. The large variation in intensity of the diffraction spots is indicative of a broad size distribution—brighter, larger spots are generated by diffraction from coarser grains, and vice versa. As depicted in FIG. 2A˜D, the texturing of the metal foil undergoes remarkable transition as the effective strain increases (from the #0 original foil, to foils after 8, 16, 24 times of ARB). Specifically, after 8 cycles of ARB, the Zn foil exhibits the classical bipolar distribution of (002) basal planes, featuring a 15-25 degree deviation from the normal direction of the foil. This is caused by Zn metal's large-scale twinning, in combination with the basal slip (002)<110>.

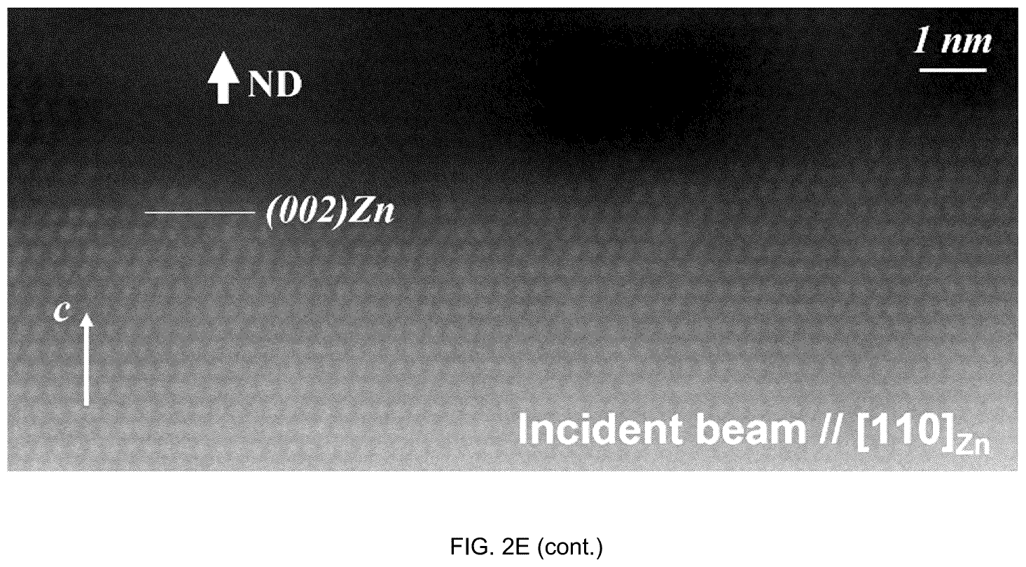

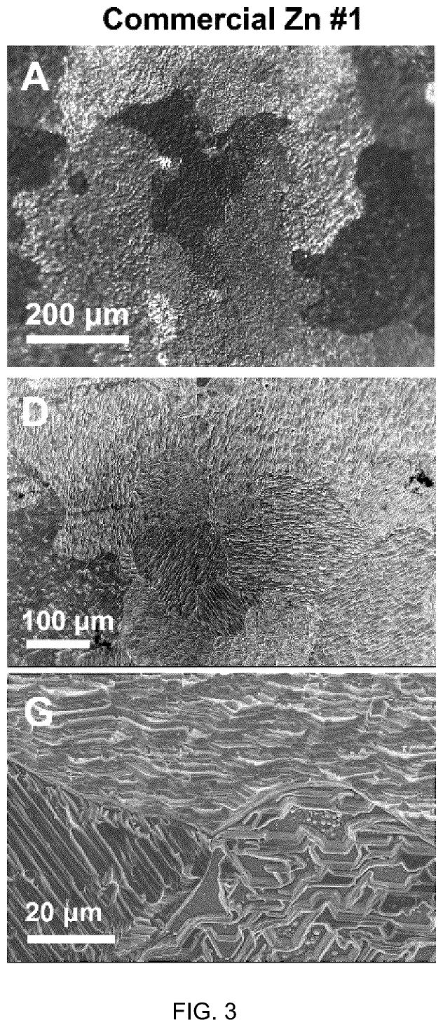

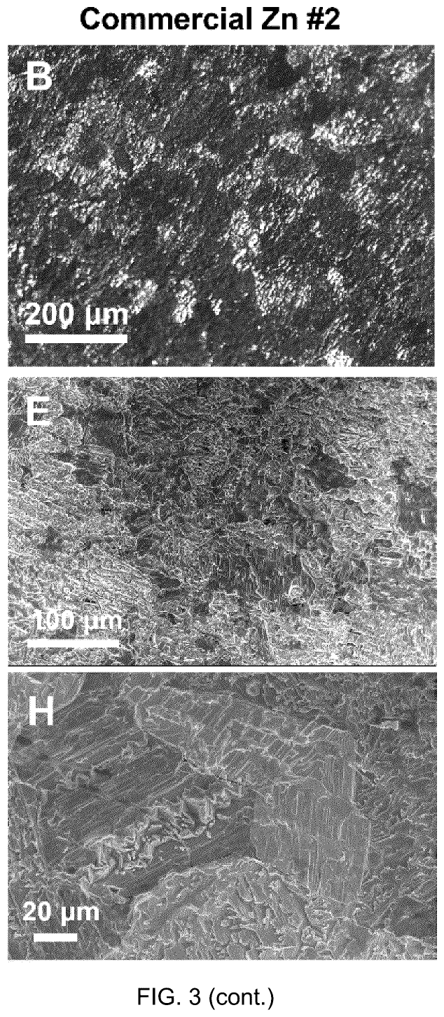

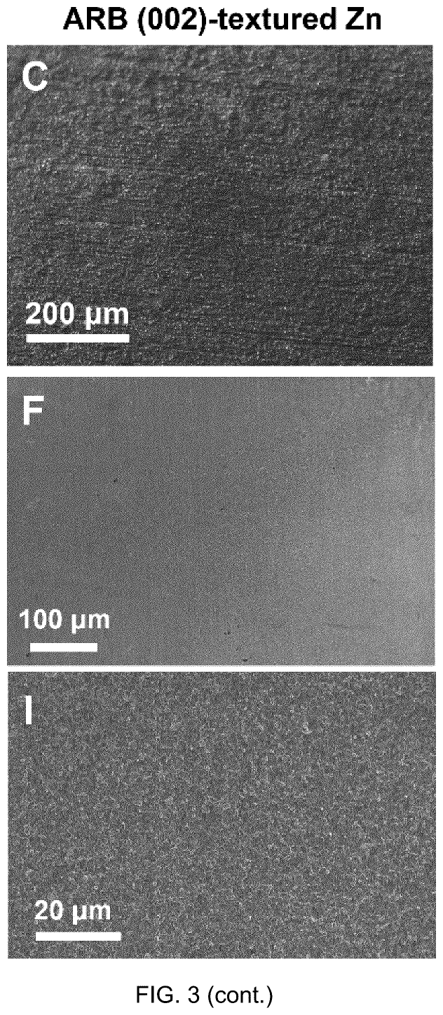

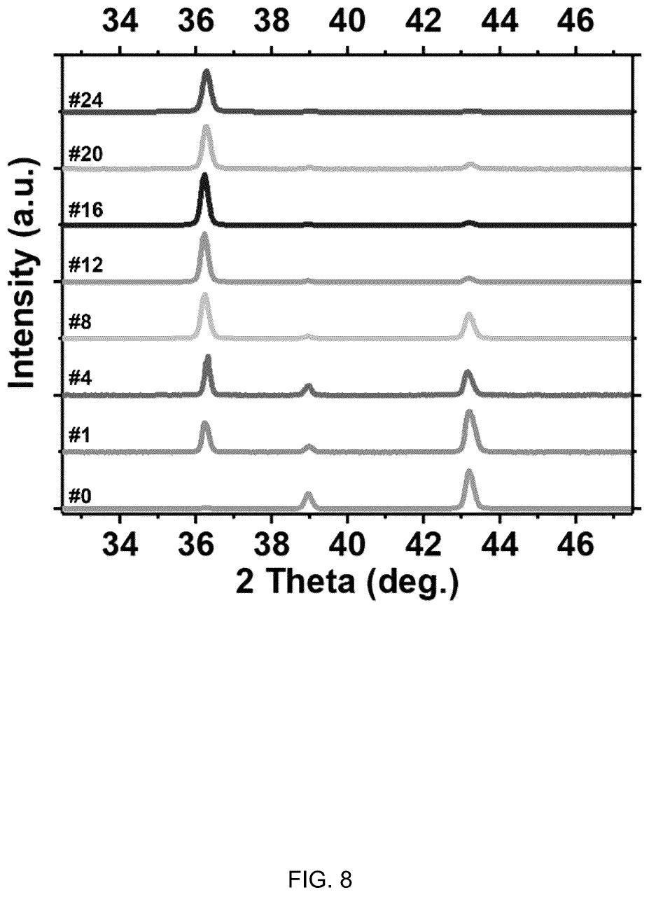

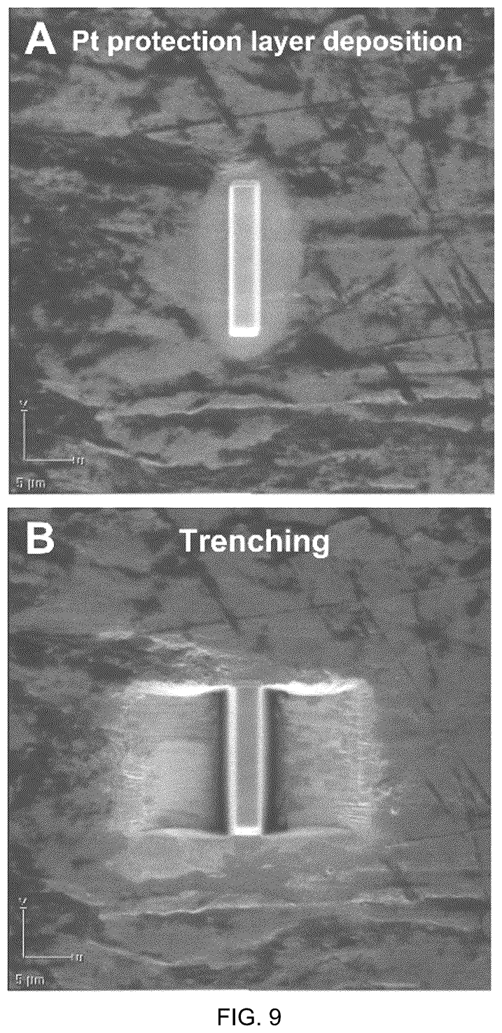

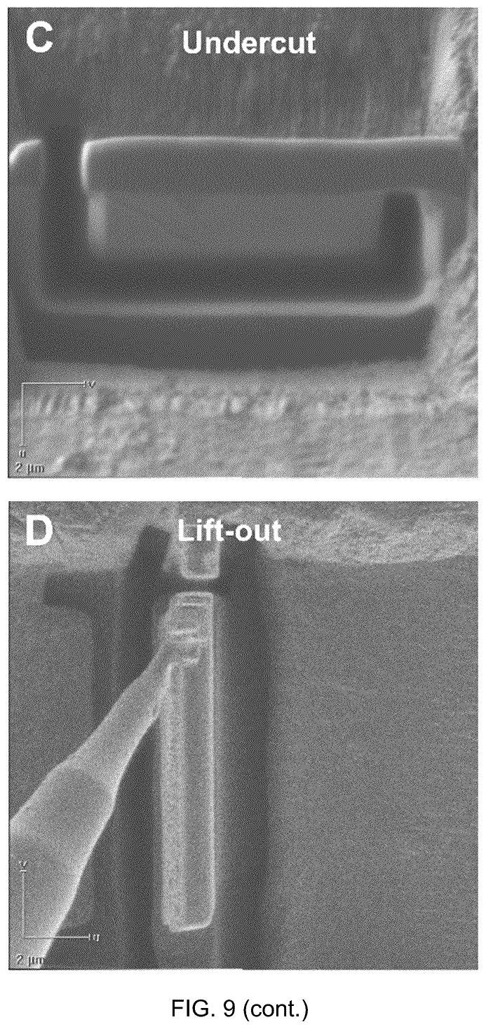

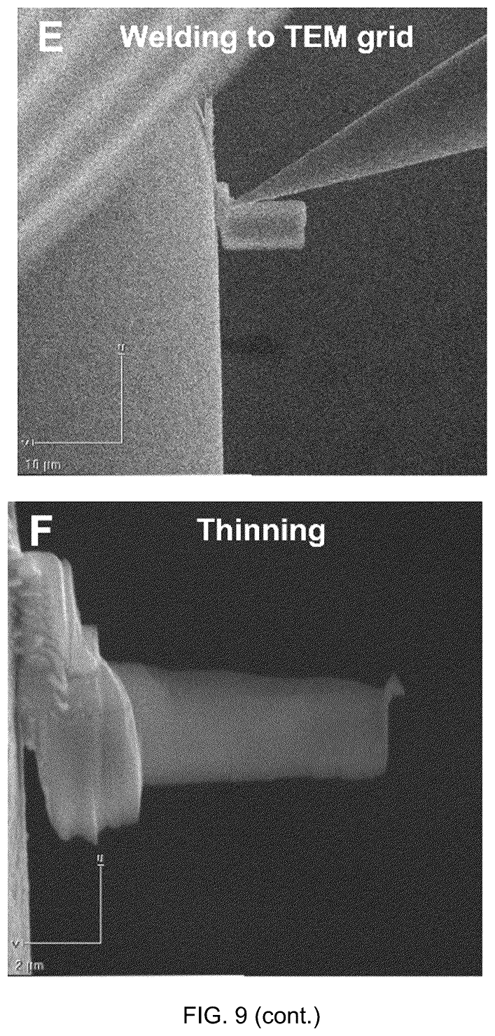

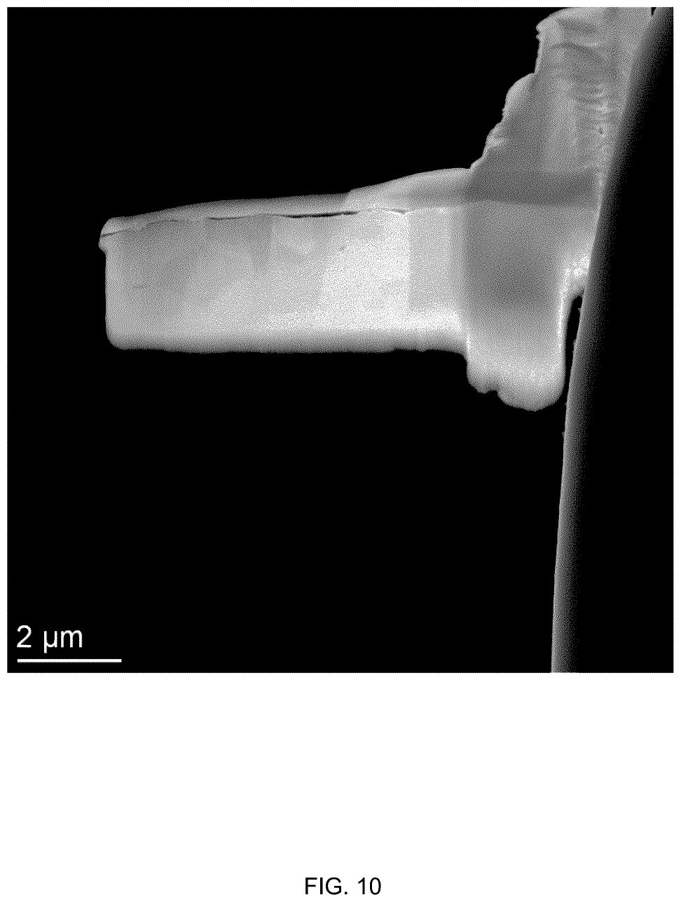

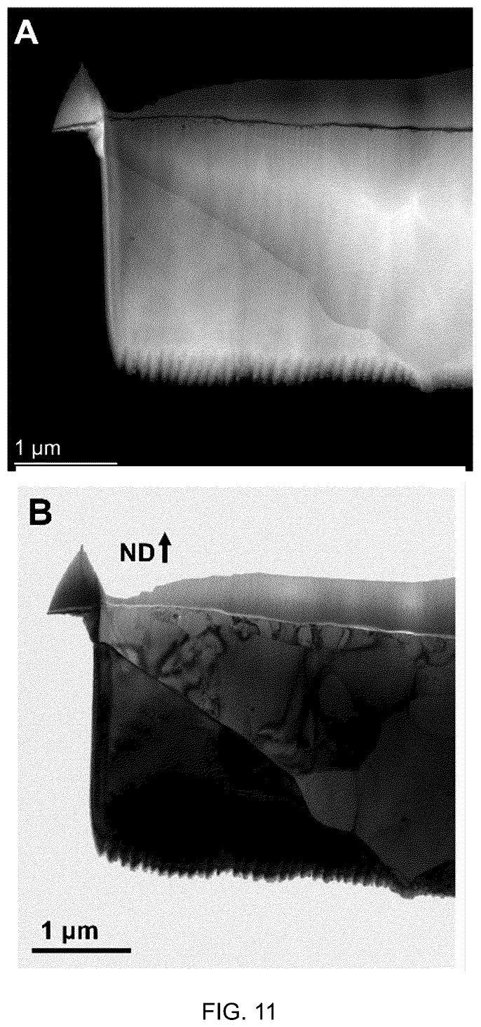

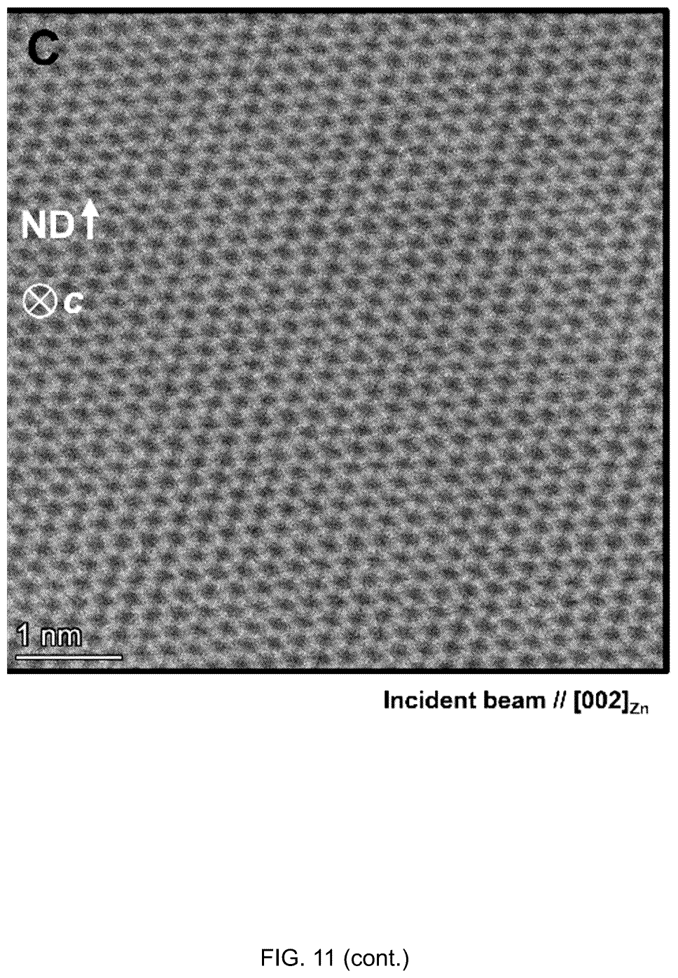

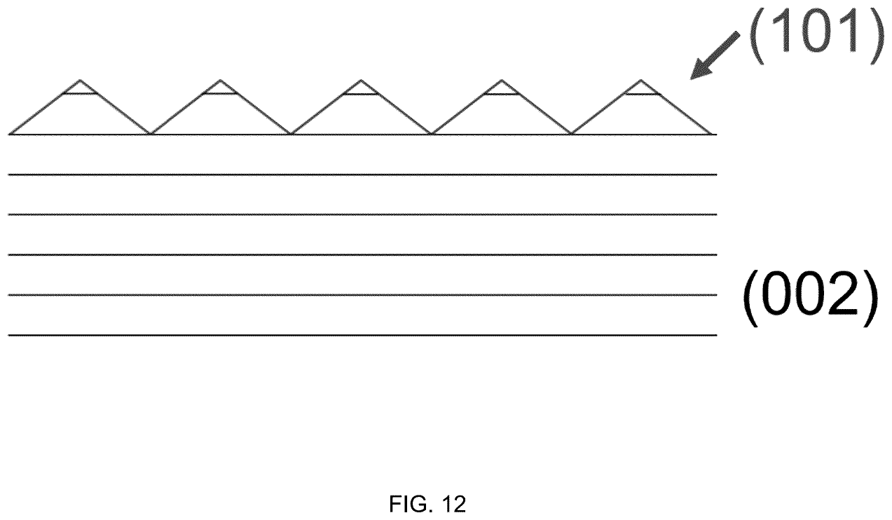

As the nominal strain further increases, the Zn metal's texture transitions from the classical bipolar pattern slightly tilted away from ND towards the two transverse directions on the sides (e.g., #8), strikingly, to a unipolar pattern (e.g., #16, #24), as can be clearly seen in FIG. 2A. This may be attributable to the nano size of the grains as will be shown in FIG. 3. Prior literature shows that the twinning in micro-grains and nano-grains occurs via different mechanisms, and the critical stress value needed to initiate twinning in nano-grains is significantly higher. FIG. 2B˜D provide detailed, quantitative analyses of such crystallographic transition processes. The ratio of (002) texture is observed to continuously increase and ultimately saturates at ˜90% after 12 times of ARB (see also FIG. 2C and FIG. 8). In the subsequent ARB process, the orientational distribution of (002) is further narrows as quantified by the full width at half maximum (FWHM) of the (002) diffraction intensity along the χ angle. We further characterized the crystallographic structures of the Zn foils using advanced nano-characterization techniques, including focused ion beam (FIB; see FIG. 9) and Cs-corrected high angle annular dark field—scanning transmission electron microscopy (HAADF-STEM). Using an incident beam parallel to [110]_{Zn} zone axis, the HAADF images show that the Zn foil after ARB is strongly (002)_{Zn} textured (FIG. 2E, FIG. 10), whereas the as-received Zn foil is not (FIG. 11), consistent with the XRD analysis. The atomic-resolution imaging technique also provides additional information about the local, surface crystallography that XRD can not capture. A strong (002) texture does not guarantee a (002) surface termination if significant roughness is developed on the surface (see a schematic diagram in FIG. 12). The HAADF images in FIG. 2E show that both the bulk and the surface of the sample is composed of (002)_{Zn} atomic planes parallel to the foil surface. Taken together, the X-ray diffraction and the HAADF-STEM imaging results unambiguously confirm that the built-in crystallographic heterogeneity of the Zn metal electrode is strictly regulated via the ARB process as we hypothesized earlier.

We employed optical microscopy techniques to characterize the metallographic features of these metal foils on larger length scales (FIG. 3). Following standard metallographic characterization procedures, the metal foils are subject to an electro-stripping (polishing) process before observation to remove surface impurities and to unveil the landscape of the grains. In the anodization process, different facets show distinct dissolution rate, leading to a height variation across the grains of different orientations. Such height variation constitutes the contrast in optical microscopy images (FIG. 3A˜C). On two conventional commercial Zn foils, coarse grains with a large size and orientation distribution are observed (FIG. 3A˜B), in stark contrast to the uniform metallography of (002)-textured Zn foil (FIG. 3C). This is consistent with the SEM observations showing the metallographic features at a smaller length scale. While the commercial foils exhibit large morphological heterogeneity after the electrostripping (FIG. 3D˜E, G˜H), the (002)-textured Zn persistently show homogeneity down to the nanoscale. These metallographic characterization results corroborate the observations made based on X-ray diffraction, and also suggest that the (002)-textured Zn foil maintains the morphological homogeneity during electro-stripping.

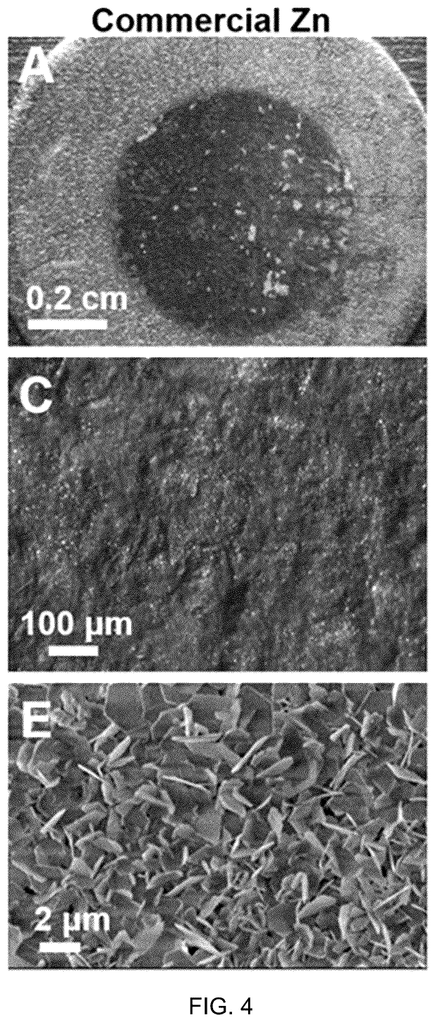

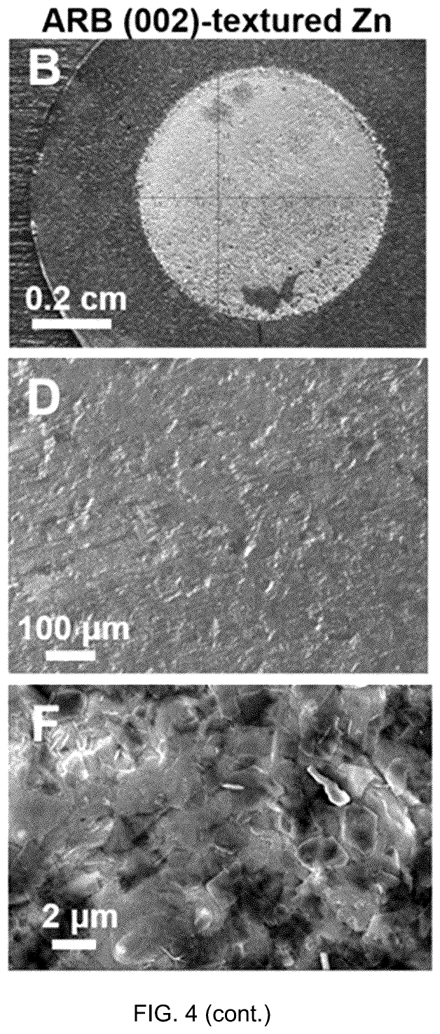

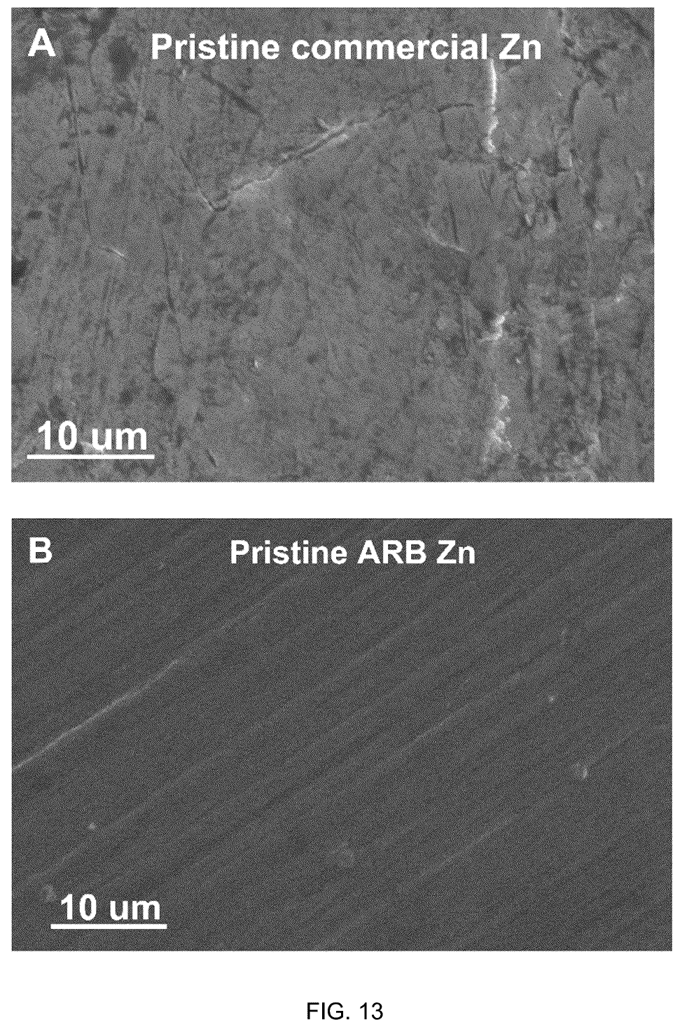

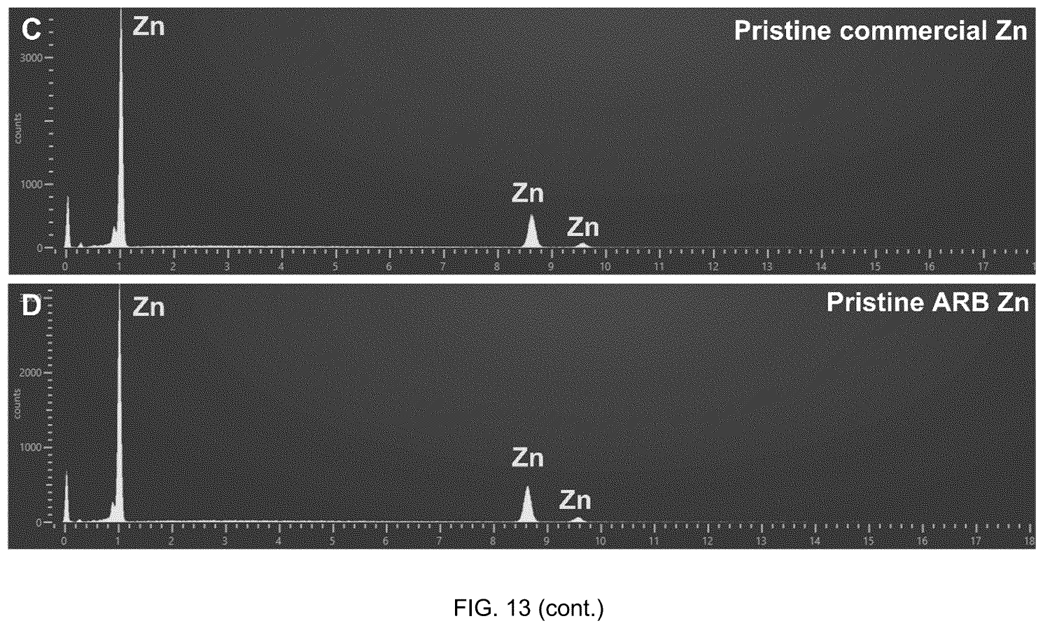

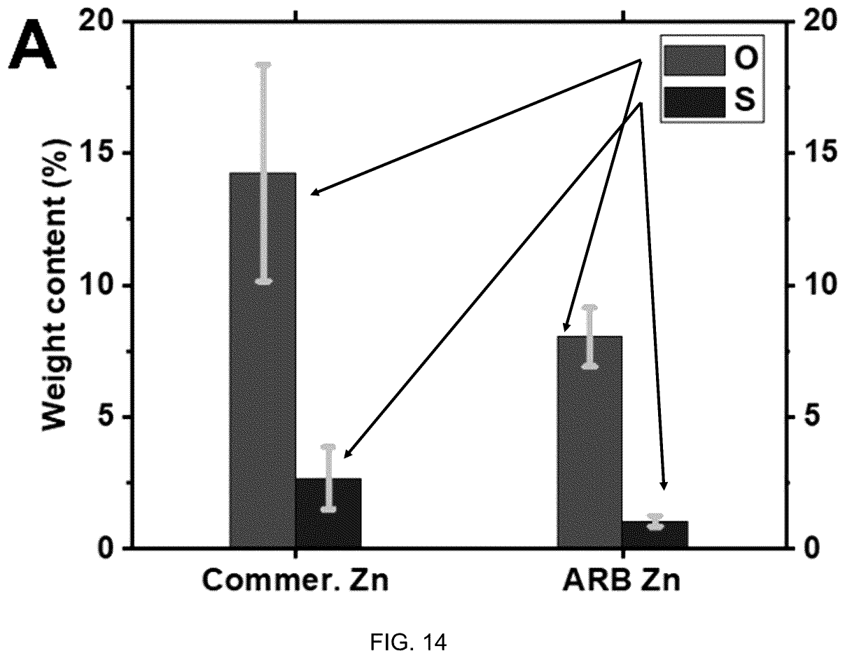

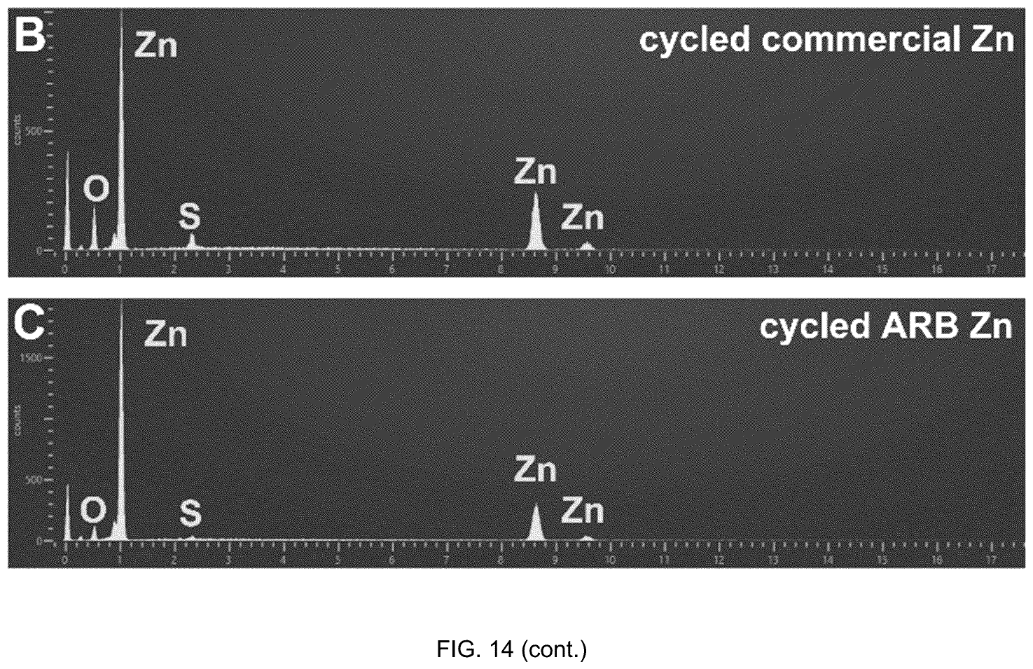

We next evaluated the electroplating/stripping morphology evolution on metal foils of representative crystallographic features. FIG. 4 shows the surface morphology of the Zn electrodes at multiple length scales after plating/stripping cycling in electrochemical cells using 2M ZnSO₄(aq)—a mild-pH electrolyte of interest in the development of commercially-competitive Zn batteries. As can be clearing seen in the photos and the optical microscopy images of the electrodes after cycling (FIG. 4A˜D), the Zn electrodeposits are grey, porous on commercial Zn foil, but shiny, compact on textured Zn foil. The origins of these two morphologies in stark on contrast can be traced by examining the detailed growth mode of electrodeposited Zn on the foils. On the commercial Zn foil, the electrodeposit is comprised of randomly-oriented Zn plates (FIG. 4E), forming a porous network, which is widely reported in the literature, and this pattern is also detected on Zn deposits on inert stainless-steel substrates. Without regulation, the intrinsic growth mode of Zn deposits is the assembly of randomly-oriented Zn plates, which unfortunately leads to “dead”/“orphaned” Zn and battery short. On (002)-textured Zn foil, the Zn deposits remain the plate-like morphology but are horizontally aligned and show a compact deposition morphology. Chemical analyses show that the contents of oxygen and sulfur on ARB Zn after cycling are remarkably lower than commercial Zn (FIGS. 13-14), suggesting a reduced parasitic reaction rate on and a higher chemical stability of (002)-textured Zn. The comparison between the two morphologies suggests that homoepitaxy effectively dominates the deposition and promotes a uniform, planar surface morphology during cell cycling.

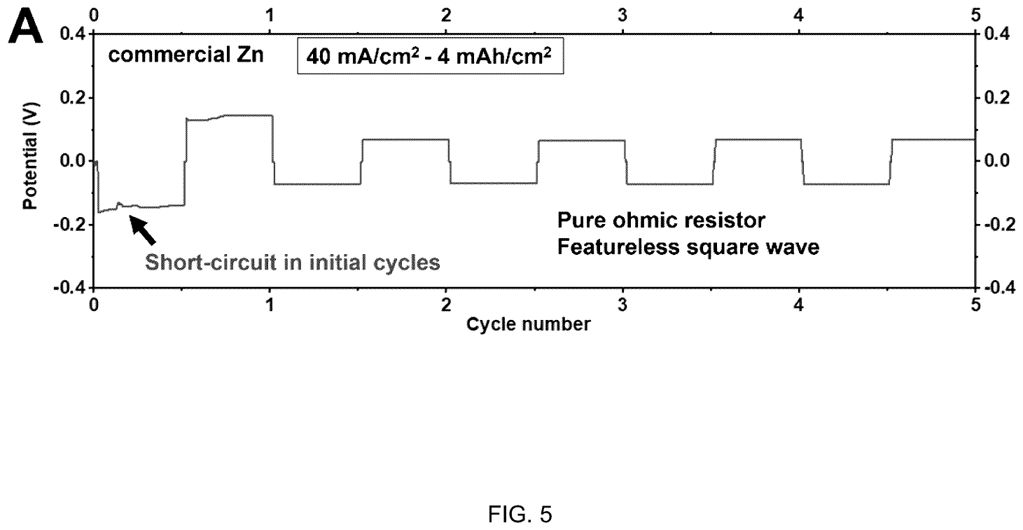

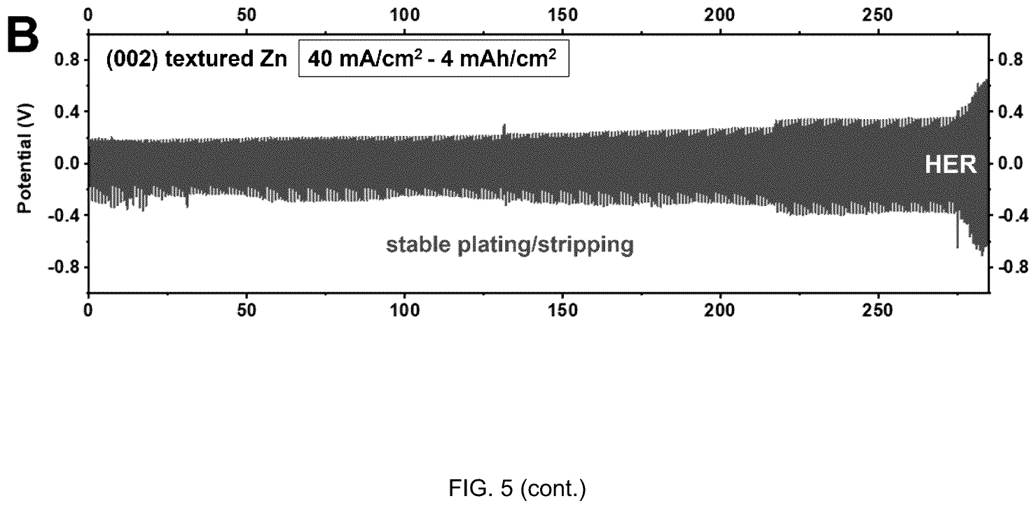

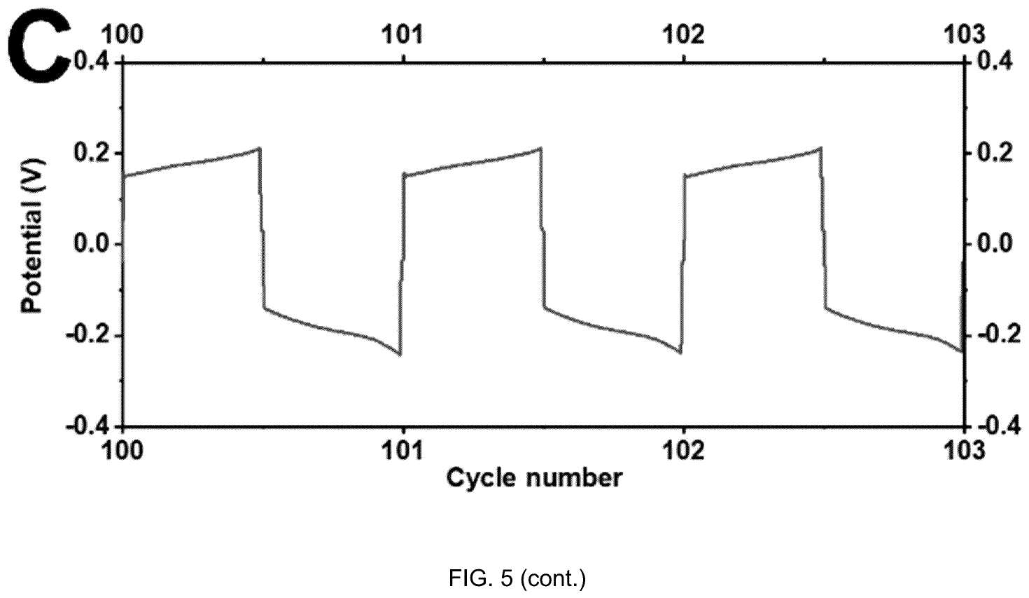

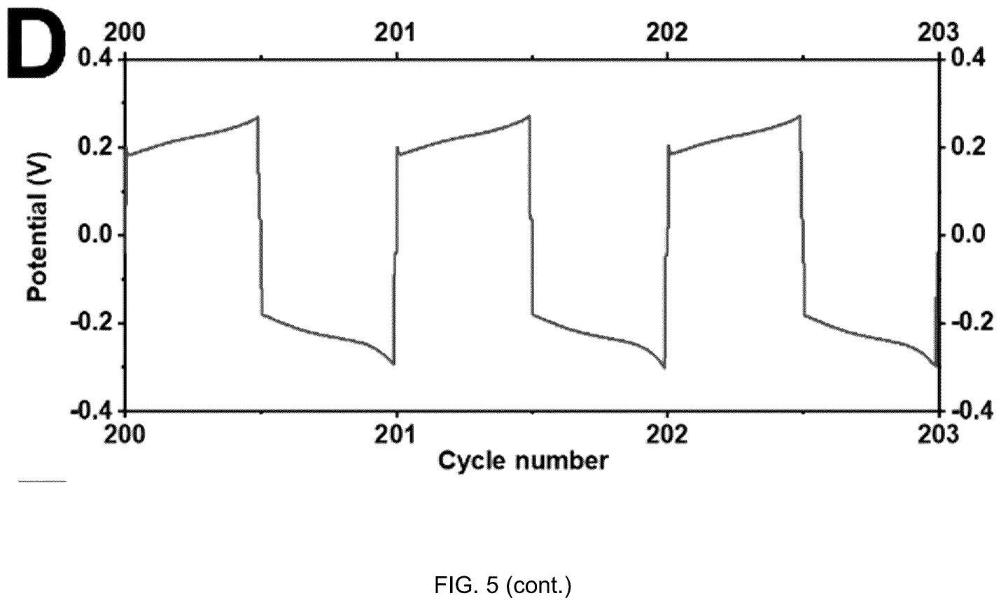

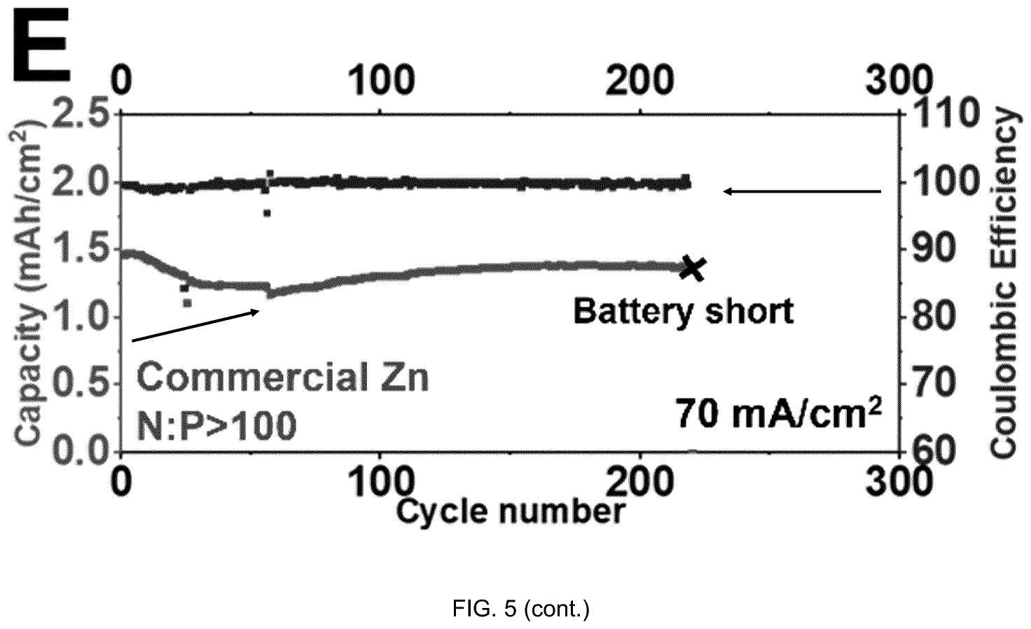

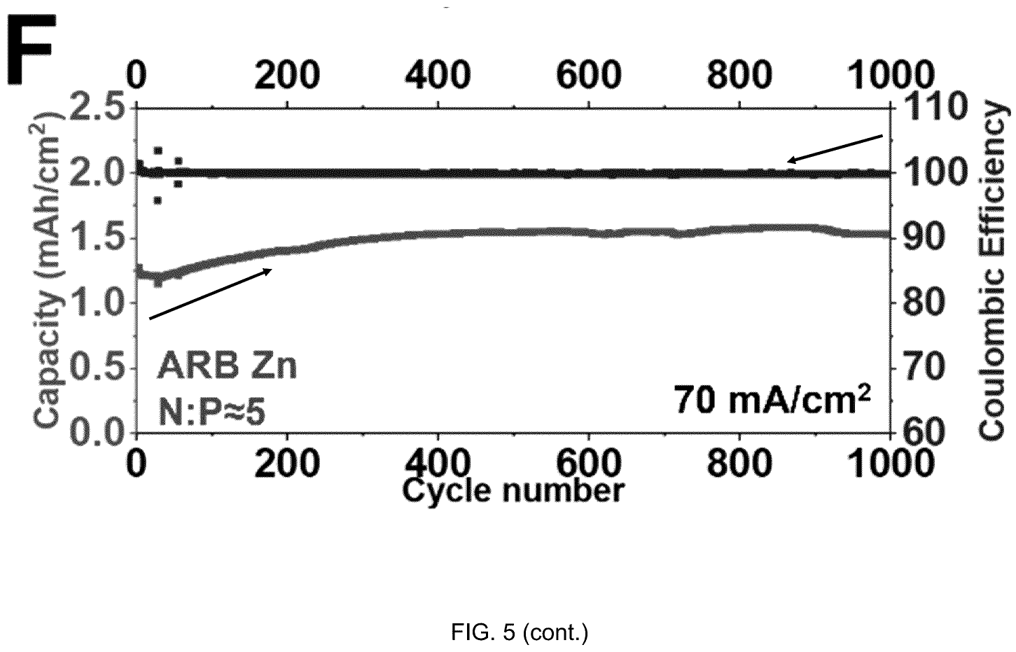

Following an established protocol reported in prior literature, we assembled Zn∥Zn symmetric cells to assess the influence of built-in crystallographic features on the stability of electrochemical cycling (FIG. 5). A stringent cycling condition—a areal capacity of 4 mAh/cm² at a current density of 40 mA/cm²—is chosen to ensure the measurement is of direct practicality. Of particular note is that this pair of current density and areal capacity is at least one order of magnitude higher than state-of-the-art literature, but is more relevant to commercially viable battery cycling conditions. Results show that the cell using commercial Zn electrodes shorts in the very initial cycles, evidenced by the square-wave potential profile without any plating/stripping signatures (FIG. 5A). The cells using (002)-textured Zn electrodes, in stark contrast, demonstrate stable plating/stripping behaviors under this stringent condition over hundreds of cycles (FIG. 5B˜D). In this context, (002) Zn exhibits higher chemical stability and better corrosion-resistance due to its high atomic density, as recognized in multiple prior studies. Taken together, this group of results shows that no Zn deposit-induced instability (e.g., battery short) is observed. This argument is corroborated by results from coin-type and pouch-type full batteries we will show as follows.

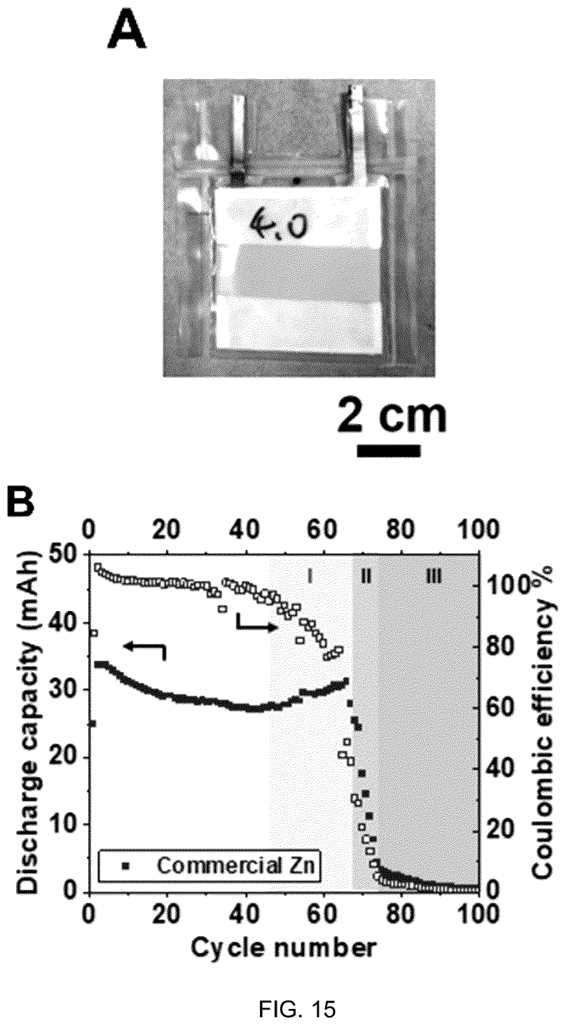

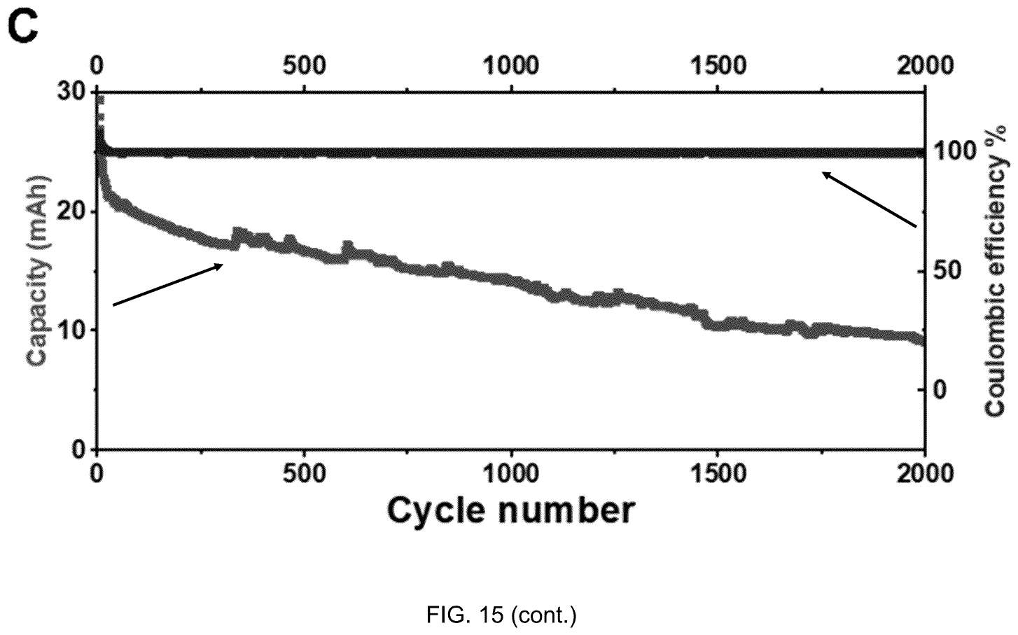

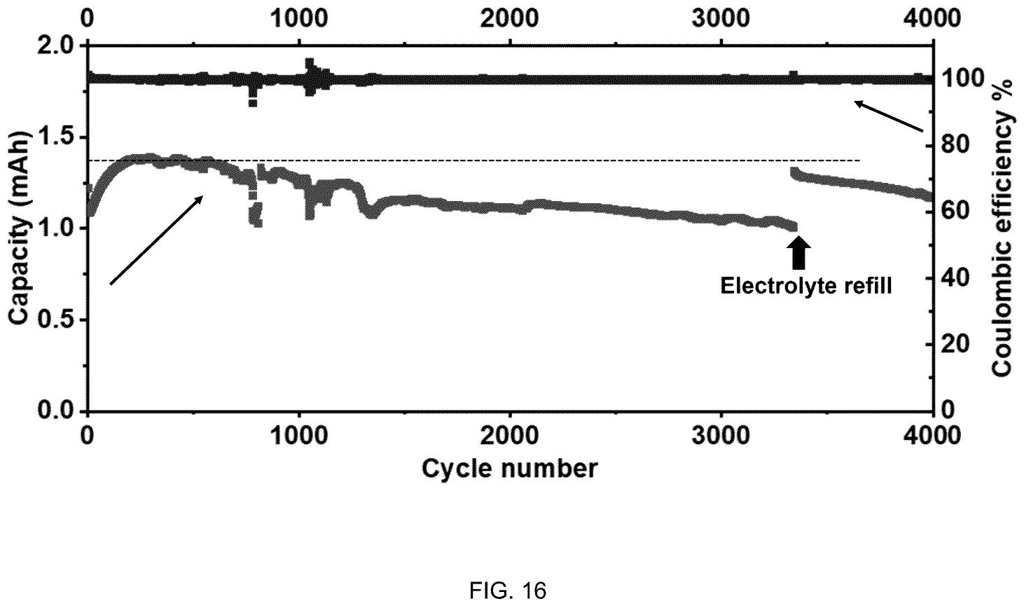

Motivated by the unprecedented electrochemical stability of the (002)-textured Zn electrodes, we fabricated Zn full batteries by pairing Zn electrodes with NaV₃O₈-based cathodes prepared by a low-cost aqueous solution-based method. In light of the scalability of both the textured Zn anode and the NaV₃O₈-based cathode and the practical cycling conditions (i.e., high current density and areal capacity), we expect the results generated from these full cell battery studies to motivate fundamental technological, as well as commercially interest in the approaches reported. FIGS. 5E˜F and FIG. 15 report results from aqueous Zn∥ NaV₃O₈ battery cycling studies performed in CR2032 coin cells, as well as in pouch cells. Consistent with the symmetric cell experiment, full batteries using commercial Zn electrodes suffer from rapid fatal battery short events, whereas the ones using (002)-textured Zn electrodes exhibit impressive stability throughout prolonged cycling test. Particularly, full batteries using ARB Zn electrodes have a N:P≈5, which is around two orders of magnitude smaller than the batteries using thick, commercial electrodes. The stabilizing effect from the crystallographic homogeneity becomes even more pronounced in pouch cells (FIG. 15). We note that, the capacity fading observed in the prolonged cycling of full batteries using textured-Zn electrodes can be largely attributed to the water decomposition (i.e. HER) and gas buildup as reported in literature. As a simple test, we observed that the capacity loss is fully recovered by refilling the electrolyte (FIG. 16). The battery assessment reported here therefore underscore the promise of the textured metal anodes reported. Given the low N:P ratio reached by thinning effect of the ARB process, it also opens up a robust technological pathway towards electrochemical energy storage systems that meet the levelized cost of energy storage (LCOS) requirement for integration into renewable energy harvesting systems, e.g., solar cells. To address this risk, we first demonstrate that the strongly-textured Zn electrodes proposed here prove to be effective in the enlarged cells in terms of stabilizing the anodes, as evidenced by the absence of battery short of any kinds over prolonged cycling. It should be noted that the Coulombic efficiency of the pouch cell using textured Zn electrode remains ˜100% throughout the entire 5,000 cycles, meaning that no internal shorts occur. The moderate gradual capacity fading is attributable to water decomposition, which can be addressed with ease by replenishing the aqueous electrolytes.

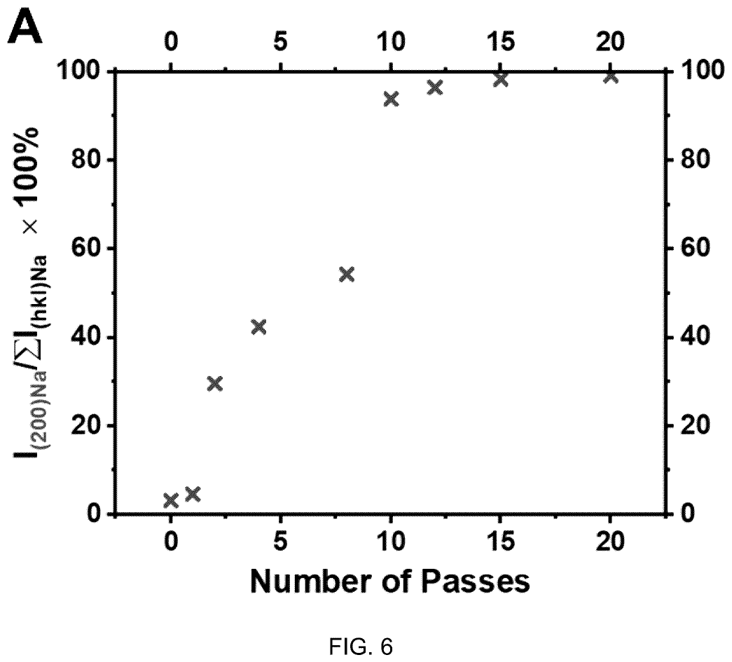

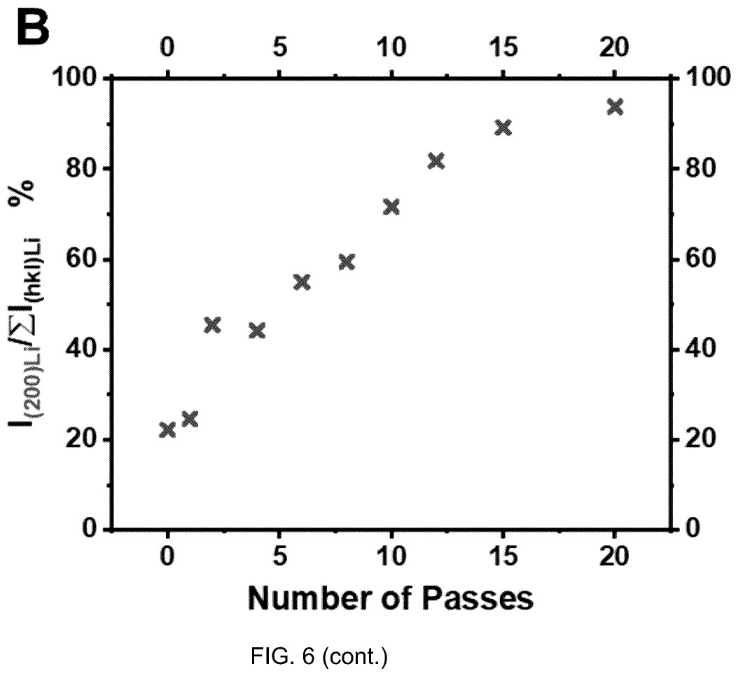

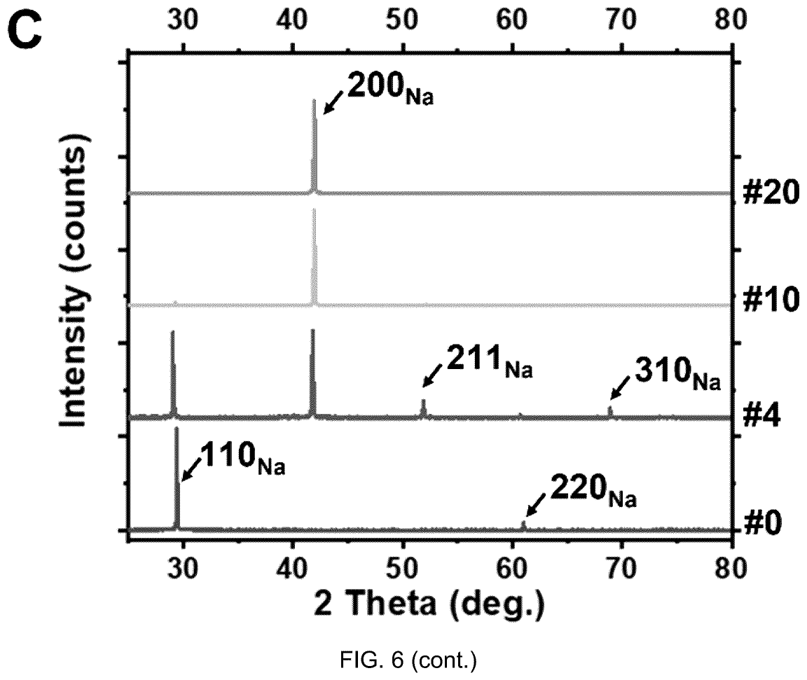

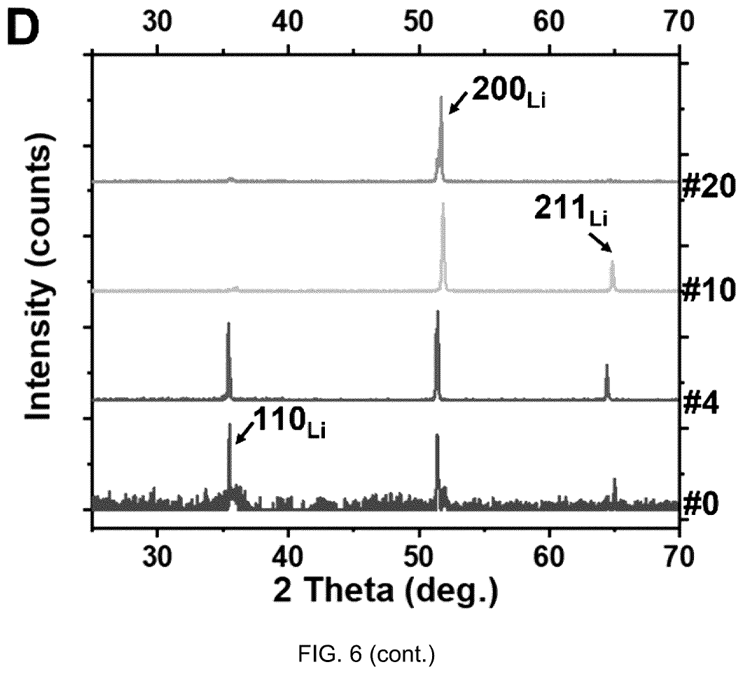

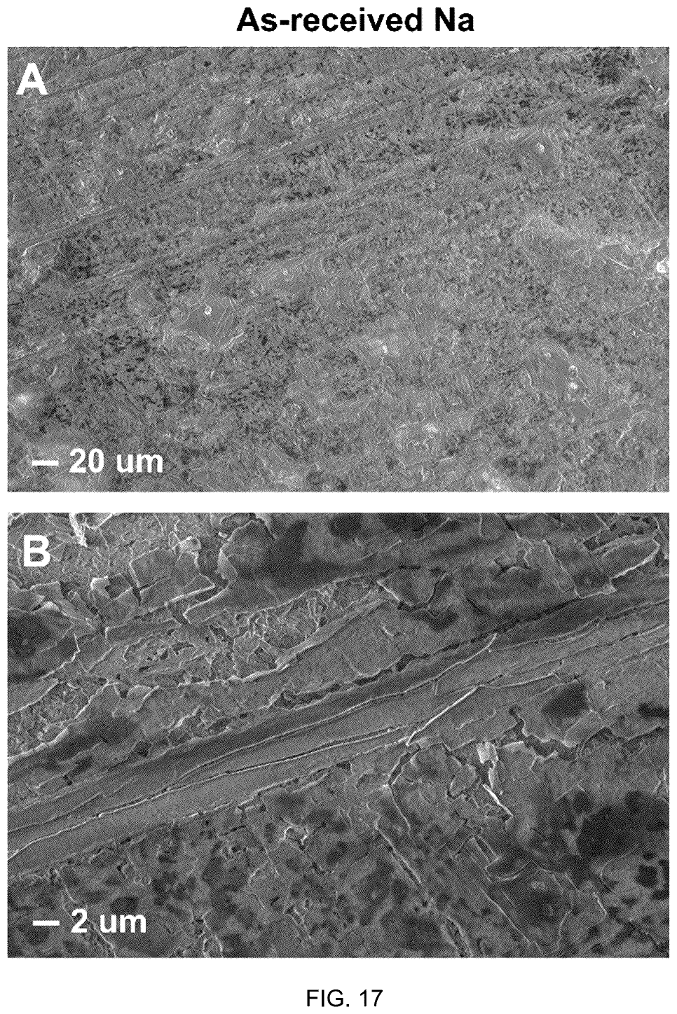

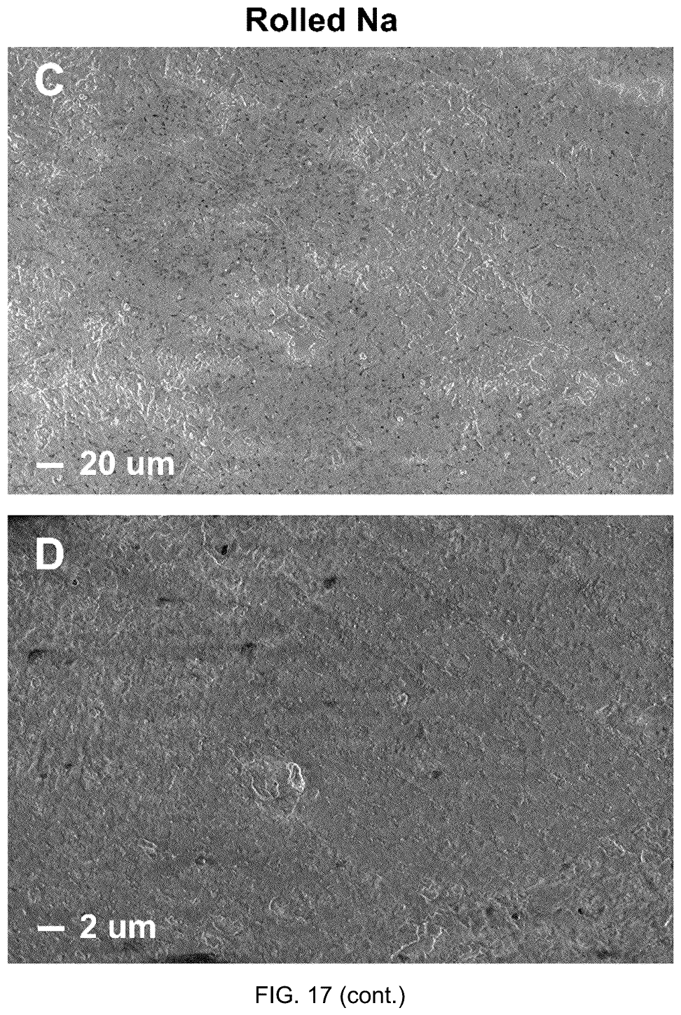

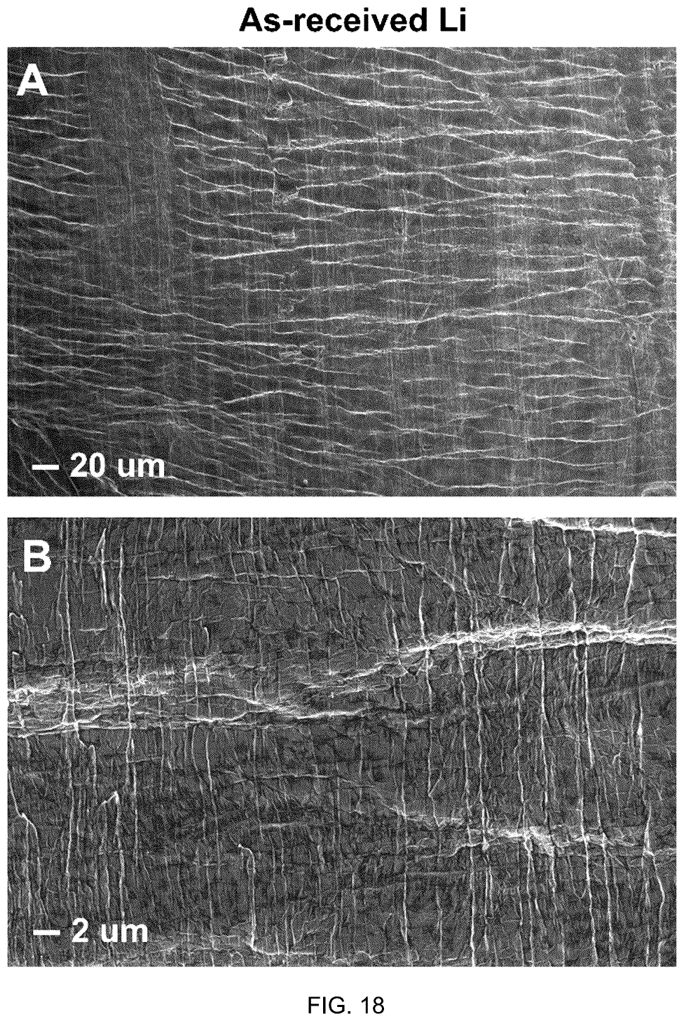

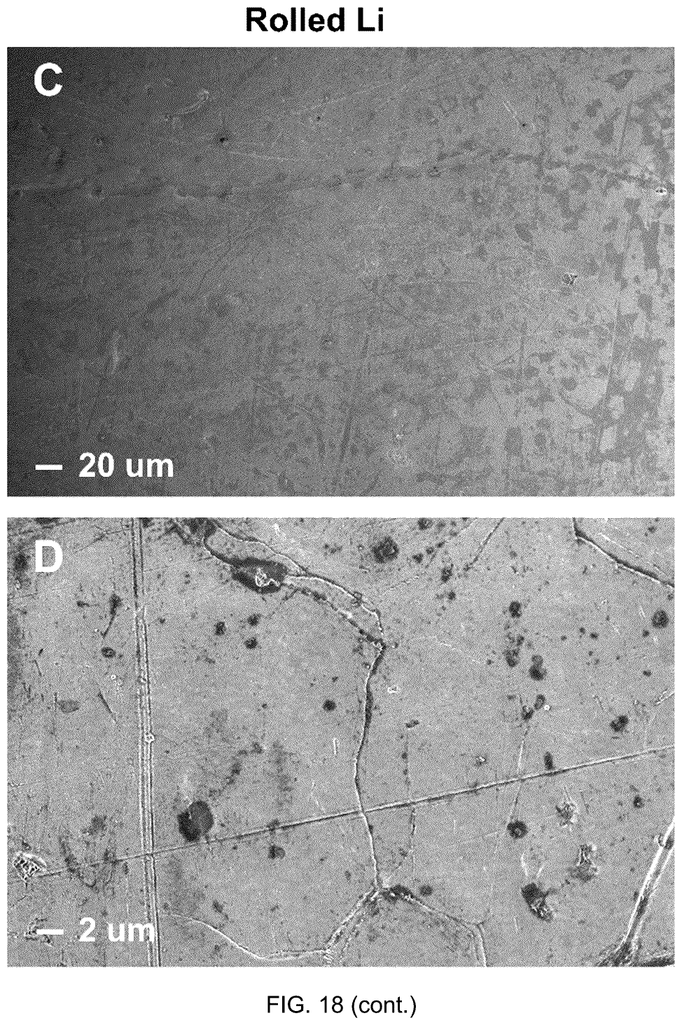

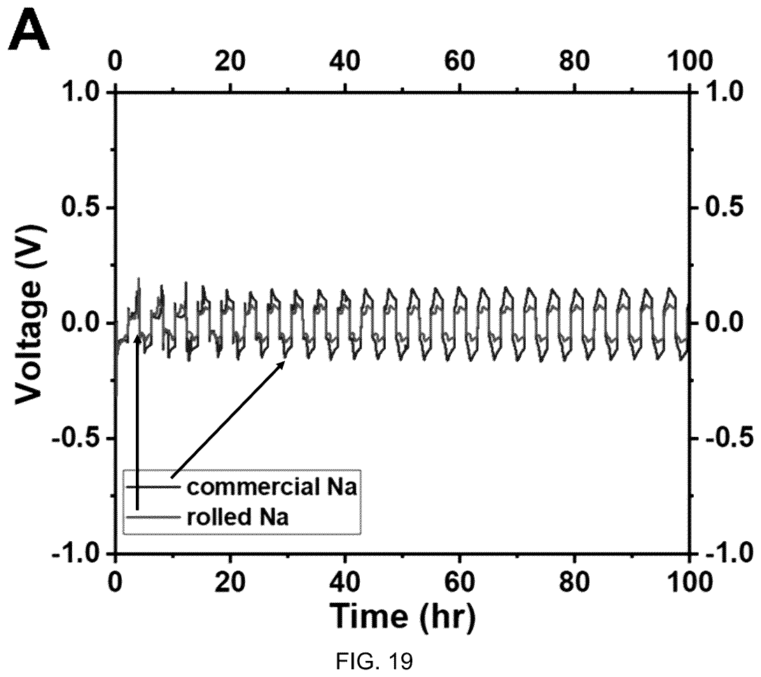

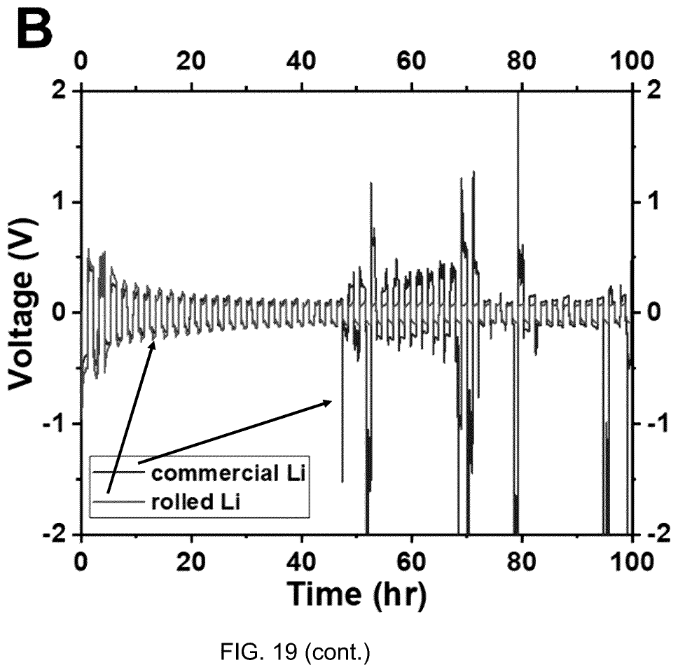

Considering the common propensity of metallic crystals for undergoing texture evolution when subject to plastic deformation, the concept of ARB-induced strong texturing should be applicable to other metals that are under active consideration as candidates for high-energy-density anodes, e.g., Li and Na. The Tₘ of Na and Li are 97.8° C. and 180.5° C., respectively. Similar to Zn, the relatively high T_{H} ensures their ductility and softness at room-temperature during the deformation process, which eliminates complications caused by brittleness and cracking. The major difference between Zn and Na/Li is that—the former belongs to a hexagonal crystal system, whereas the latter two have a body-centered cubic lattice symmetry (see crystal structures in FIG. 7). Despite the difference in crystal symmetry, we conjecture that similar slip mechanisms should hold, i.e. close packed planes along close-packed directions. FIG. 6 reports the texture evolution of Na and Li in ARB processes. Consistent with our expectations, it is observed that as the number of passes increases, both Na and Li exhibit stronger ND∥<100> texturing. Such texture evolution phenomena is consistent with previous observations made on body-centered cubic metals. After 20 passes, foils of either Li or Na become singly oriented, featuring a uniform (100) texture throughout macroscopic sections of the sample (FIG. 6). These results directly prove the general effectiveness of ARB for obtaining uniformly textured metal thin films suitable for battery anodes for hexagonal (e.g., Zn), and also cubic (e.g., Li and Na) metallic crystalline materials. We next examine the influence of the achieved crystallographic homogeneity on electrochemical behaviors by visualizing the surface morphology of the electrochemically anodized metal electrode (Li and Na, see FIG. 14-15). The strongly-textured metal electrodes show a remarkably smoother interface than what is formed on as-received electrodes. The smooth electrochemical interface on strongly-textured Li/Na electrodes stabilizes the plating/stripping cycling of the metals (FIGS. 16-19). These results show that, consistent with arguments based on Zn, the built-in crystallographic homogeneity plays a critical but oftentimes underexplored role in metal anodes that have cubic lattices (e.g., Li and Na). We further point out that, due to their smaller crystal anisotropy, the deformation texture of cubic metals shows a nontrivial dependence on specific deformation. As such, theoretical analysis could single out the possible texture components (see Table 2), whereas the actual deformation texture is probed by experimental methods. We note that, this relatively high degree of freedom associated with rolling texture of cubic metals creates substantial space for achieving task-specific textures that best stabilizes the plating/stripping process with carefully designing the deformation protocol.

In summary, we report severe plastic deformation as an effective approach to eliminate in-built crystallographic heterogeneity in metal electrodes of interest for next-generation rechargeable batteries. As a proof-of-concept demonstration, we show that repeated rolling can significantly increase the (002) basal texture of HCP Zn metal, from <10% in conventional foils to >90%. We further show that as the nominal strain exceeds a critical value, the (002) texture of the Zn grains transition from the classical bipolar pattern to a unipolar pattern—a previously unexplored regime. The electrodeposition of Zn on the textured (002) electrode is dominated by compact, horizontal growth of the Zn plates, suggestive of a homoepitaxy process. This is in stark contrast to the porous, randomly-oriented growth of Zn plates on commercial Zn foil. Cell cycling results show that the (002)-textured electrodes sustain hundreds of cycles under stringent testing conditions (e.g., 4 mAh/cm² at 40 mA/cm²), whereas cells using commercial electrodes short in the initial cycles. The findings reported here generate new perspectives for developing next-generation metal anodes for rechargeable batteries. The concept is extended to two other metals of contemporary interest, Li and Na with very different crystallography and interfacial energetics in batteries. Remarkably we find that it is as effective in creating uniformly textured films of both materials and that the texturing applies over macroscopic domains. The simplicity of our approach for manipulating the built-in crystallographic properties and the subsequent plating/stripping reversibility achieved, should revive interest in other metals (e.g., Li, Na, K, Mg, Ca, Al etc.) that are of contemporary interest for next-generation secondary batteries.

Materials and Methods. Materials and electrolytes. 0.25 mm Zn foil (99.9%), ZnSO₄·7H₂O were purchased from Sigma Aldrich. Zn electrolyte preparation: ZnSO₄·7H₂O was dissolved into the deionized water to prepare the ZnSO₄ electrolytes for Zn batteries. Deionized water was obtained from Milli-Q water purification system. The resistivity of the deionized water is 18.2 MΩcm at room temperature. Battery grade 1.0M lithium hexafluorophosphate (LiPF₆) in ethylene carbonate/dimethyl carbonate (EC/DMC)=50/50(v/v) purchased from Sigma-Aldrich was directly used as the electrolyte for Li cell assembly. Electrolyte for Na cells was prepared in the lab by dissolving 1.0M sodium hexafluorophosphate (NaPF₆) in anhydrous, 99.5% diethylene glycol dimethyl ether, followed by further drying using molecular sieve. NaPF₆ as well as glycol dimethyl ether were both purchased from Sigma-Aldrich.

Deformation by accumulative roll bonding (ARB). MSK-HRP-MR100DC Roller Press was used for rolling the metal in interests. The rolling speed was set as 15 mm/s for all experiments. The roller gap was set to be the same as the original thickness of the metal ribbon. For each rolling press, the metal ribbon was folded in half, and sent through the roller press. The deformation process was performed at room temperature. After deformation, ARB-treated Zn foils were annealed in a 50° C. furnace for 30 minutes before characterization and use.

Characterization of materials. Field-emission scanning electron microscopy (FESEM) was carried out on Zeiss Gemini 500 Scanning Electron Microscope. Linear sweep voltammetry and chronoamperometry was performed using a CH 600E electrochemical workstation. 2D X-ray diffraction and power X-ray diffraction was performed on Bruker D8 General Area Detector Diffraction System and Bruker D8 Advance ECO powder diffractometer, respectively, both of which use a Cu Kα X-ray source. Focused ion beam (FIB) was performed on VELION manufactured by Raith. Aberration-corrected high angle annular dark field—scanning transmission electron microscopy (HAADF-STEM) was carried out on FEI Themis.

Electrochemical measurements. All the coin cells in this study are in the CR2032 format. Whatman Glass fiber B was used as the separator with ˜100 μL electrolyte for Zn cells. NaV₃O₈-based cathode material was synthesized according to a method reported in prior literature. To enable high areal mass loadings, we utilized the nonplanar electrode architectures we reported earlier. For Li cells, Celgard 3501 was used as the separator, where 60 μL electrolyte as described above was added to each cell. For Na cells that were later used in SEM surface characterization, Celgard 2325 was used as the separator, where 60 μL electrolyte as described above was added to each cell The metal plate was then taken out from the coin cell, washed with DMC, dried under vacuum, and performed SEM imaging for evaluating its surface morphology. For symmetric cell cycling, Whatman glass fiber grade GF/B was used as the separator with 150 μL of electrolyte.

Although the present disclosure has been described with respect to one or more particular embodiments and/or examples, it will be understood that other embodiments and/or examples of the present disclosure may be made without departing from the scope of the present disclosure.

1. A method of making a textured metal layer comprising:
rolling a metal; and
folding the rolled metal.

2. The method of claim 1, wherein the rolling and folding are repeated from 1 to 20 times.

3. The method of claim 1, wherein the metal is a metal foil, a metal film, a metal ribbon, a metal strip, or a metal tape.

4. The method of claim 1, wherein the rolling results in severe plastic deformation (SPD) of the metal.

5. The method of claim 1, wherein the rolling results in anisotropic deformation(s) of the metal.

6. The method of claim 5, wherein the anisotropic deformation(s) are in-plane shear.

7. The method of claim 1, wherein the rolling results in in-plane alignment of one or more crystal plane(s) of the metal in-plane and out-of-plane alignment of one or more crystal plane(s) of the metal.

8. The method of claim 7, wherein the alignment occurs preferentially of one or more or all (002) plane(s) in a hexagonal close packed metal, at one or more or all (110) plane(s) in a body-centered cubic (bcc) metal, or one or more or all (111) plane(s) in a face centered cubic metal.

9. The method of claim 1, wherein each rolling is independently carried out at a temperature of about 0.3 to about 0.99 of the melting temperature (Tₘ) of the metal.

10. The method of claim 1, wherein each folding is folding the metal in half.

11. The method of claim 1, wherein the metal is a hexagonal close packed metal, a bcc metal, or a fcc metal, or the metal exhibits a homologous temperature (T_{H}) of greater than or equal to about 0.4, or both.

12. The method of claim 1, wherein the metal comprises potassium, sodium, lithium, zinc, magnesium, aluminum, calcium, or any combination thereof.

13. The method of claim 1, wherein the metal comprises a metal chosen from gold, silver, indium, tin, cerium, lanthanum, thulium, zirconium, titanium, iron, chromium, and combinations thereof.

14. An anode comprising:
i) a textured metal layer of claim 1, or
ii) a textured metal layer of claim 1 disposed on at least a portion of a metal member.

15. The anode of claim 14, wherein the textured metal layer is a metal member and comprises a metal chosen from gold, silver, zirconium, titanium, iron, chromium, and combinations thereof.

16. The anode of claim 14, wherein the textured metal layer comprises potassium, sodium, lithium, zinc, magnesium, aluminum, calcium, or any combination thereof.

17. The anode of claim 14, wherein the textured metal layer is crystalline.

18. The anode of claim 17, wherein at least a portion or all of an exterior surface of the textured metal comprises crystal facets chosen from a (001) plane in hexagonal closest packed structure, a (111) plane in face centered cubic structure, and a (110) plane in body centered cubic structure.

19. The anode of claim 18, wherein 80%-100% of the crystal facets of the textured metal are a (001) plane in hexagonal closest packed structure, a (111) plane in face centered cubic structure, or a (110) plane in body centered cubic structure.

20. The anode of claim 14, wherein the textured metal layer comprises a plurality of grains, wherein each grain independently comprises a longest linear dimension of about 5 nanometers to about less than about 1 micron.

21. The anode of claim 14, wherein the thickness of the textured metal layer is about nanometers to about 5 centimeters.

22. The anode of claim 14, further comprising an electrodeposited layer disposed on at least a portion of the textured metal layer.

23. A device comprising one or more anode(s) of claim 14.

24. The device of claim 23, wherein the device is an electrochemical device.

25. The device of claim 23, wherein the electrochemical device is a battery, a supercapacitor, a fuel cell, an electrolyzer, or an electrolytic cell.

26. The device of claim 25, wherein the battery is a metal ion-conducting battery.

27. The device of claim 26, wherein the ion-conducting battery is a lithium-ion conducting battery, a potassium-ion conducting battery, a sodium-ion conducting battery, a calcium-ion conducting battery, a magnesium-ion conducting battery, a zinc-ion conducting battery, an aluminum-ion conducting battery, or an iron-ion conducting battery.

28. The device of claim 25, wherein the battery exhibits one or more or all of the following:
the battery does not exhibit detectible dendritic growth and/or orphaning; and/or
a battery exhibits at least 1,000 charging/discharging cycles without failure; and/or
an areal capacity of about 0.5 to about 50 mAh/cm² at a current density of about 0.1 to about 100 mA/cm²; and/or
an N:P ratio of about 0 to about 10; and/or
a current density of about 0.1 to about 100 mA/cm².
